(19) United States
(12) Patent Application Publication
(10) Pub. No.: US 2024/0181433 A1
(43) Pub. Date: Jun. 6, 2024

(54) PTFE AND ACTIVE PARTICLE COMPOSITIONS

(71) Applicant: Donaldson Company, Inc., Bloomington, MN (US)

(72) Inventors: Shane Lawson, Waconia, MN (US); Davis B. Moravec, Burnsville, MN (US); Yehya A. Elsayed, Bloomington, MN (US); Anil Suthar, Eden Prairie, MN (US)

(21) Appl. No.: 18/527,018

(22) Filed: Dec. 1, 2023

Related U.S. Application Data
(60) Provisional application No. 63/429,963, filed on Dec. 2, 2022.

(51) Int. Cl. B01J 20/32; B01D 53/86; B01J 20/02; B01J 23/34; B01J 23/72; B01J 31/06

(52) U.S. Cl. CPC B01J 20/321; B01D 53/8675; B01J 20/0222; B01J 20/0237; B01J 20/3293; B01J 23/34; B01J 23/72; B01J 31/06; B01D 2255/2065; B01D 2255/2073; B01D 2255/20761; B01J 2220/46

(57) ABSTRACT

Compositions including a matrix, methods of making such compositions, structures including such compositions, methods of disposing such compositions on a substrate; wherein the matrix includes: a plurality of polytetrafluroethylene fibrils formed from PTFE resin and a plurality of active particles.

### CROSS-REFERENCE TO RELATED APPLICATION

This application claims the benefit of U.S. Provisional Patent Application No. 63/429,963, filed Dec. 2, 2022, which is incorporated herein by reference in its entirety.

### BACKGROUND

Catalysts and sorbents (adsorbents and absorbents) can be used to remove unwanted chemicals from a fluid (e.g., a gas or a liquid). For example, catalysts can be used to destroy chemicals such as ozone. Sorbents can be used to isolate or remove acidic molecules, basic molecules, ozone, or other various organic or inorganic compounds from fluids. Catalysts and sorbents may be difficult to handle when in a powdered or particulate form. As such, catalysts and sorbents are often secured onto a support. Securing a catalyst or absorbent onto a support may make the catalyst or absorbent easier to handle; however, securing the catalyst or absorbent to the support may reduce the surface area of the catalyst or absorbent available to remove the unwanted chemicals from the fluid. Additionally, the physical and chemical properties of the support may impact the functionality of the catalysts (e.g., catalytic efficiency) or sorbent. Furthermore, the physical and chemical properties of the support may impact the ultimate configuration of a product (e.g., a filter) that includes a catalyst- or absorbent-functionalized support. Ideally, a catalyst- or sorbent-functionalized support has one or more of the following characteristics: is readily shape engineered; has the catalyst or absorbent fixed in a configuration such as to display a large surface area of the catalyst or the sorbent; and resists mechanical and chemical degradation.

### SUMMARY OF THE DISCLOSURE

In one aspect, this disclosure provides a composition that comprise a matrix. The matrix comprises a plurality of polytetrafluoroethylene (PTFE) fibrils and a plurality of active particles. In some embodiments the plurality of PTFE fibrils comprises short-strand PTFE fibrils and long-strand PTFE fibrils.

In some embodiments, at least a portion of the plurality of active particles and at least a portion of the plurality of PTFE fibrils adopt a catenated structure, a conglomerated structure, or both, when the composition is in an unstretched state.

In some embodiments, the plurality of active particles comprises a catalyst, an adsorbent, a growth seed, a metal-organic framework (MOF), or any combination thereof.

In another aspect, this disclosure provides a putty, a tape, a honeycomb structure, a web structure, or a cast membrane comprising the composition of any one of the preceding aspects or embodiments.

In another aspect, this disclosure provides a substrate comprising an external surface, the composition of any one of the preceding aspects or embodiments disposed on at least a portion of the external surface.

In another aspect, this disclosure provides methods of making the composition of any one of preceding aspects or embodiments.

In another aspect, this disclosure provides methods of disposing a composition of any one of the preceding aspects or embodiments to at least a portion of an external surface of a substrate.

The terms “short-strand PTFE fibril” and “long-strand PTFE fibril” are used relative to one another. A short-strand PTFE fibril has a length that is shorter than a long-strand PTFE fibril as measure per the Dimensional Analysis Test Method. A plurality of short-strand PTFE fibrils has an average length that is shorter than the average length of a plurality of long-strand PTFE fibrils as measure per the Dimensional Analysis Test Method. The length of a fibril is the largest dimension of the fibril. Short-strand PTFE fibrils and long-strand PTFE fibrils are formed from PTFE starting materials having different average PTFE resins sizes.

As used herein, the term “active particle” refers to a particle that includes at least one component that is capable of participating in a chemical reaction (e.g., as a catalyst) and/or is capable as acting as an adsorbent and/or absorbent.

Herein, the term “comprises” and variations thereof do not have a limiting meaning where these terms appear in the description and claims. Such terms will be understood to imply the inclusion of a stated step or element, or group of steps or elements, but not the exclusion of any other step or element, or group of steps or elements. The phrase “consisting of” means including, and limited to, whatever follows the phrase “consisting of.” Thus, the phrase “consisting of” indicates that the listed elements are required or mandatory, and that no other elements may be present. The phrase “consisting essentially of” means including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may, or may not, be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

Herein, “up to” a number (e.g., up to 50) includes the number (e.g., 50). Herein, “at least” a number (e.g., at least 50) includes the number (e.g., 50). Herein, “no more than” a number (e.g., no more than 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” or “ambient temperature” refers to a temperature of 20° C. to 25° C.

The term “in the range” or “within a range” (and similar statements) includes the endpoints of the stated range.

Reference throughout this specification to “one aspect,” “an aspect,” “aspects,” “one embodiment,” “an embodiment,” “certain embodiments,” “some embodiments,” or “one or more embodiments” etc., means that a particular feature, configuration, composition, or characteristic described in connection with the embodiment or aspect is included in at least one embodiment or aspect of the disclosure. Thus, the appearances of such phrases in various places throughout this specification are not necessarily referring to the same embodiment or aspect of the disclosure. Furthermore, the particular features, configurations, compositions, or characteristics may be combined in any suitable manner in one or more embodiments or aspects.

The term “on” when used in the context of a composition or a hydrated solid disposed on a surface or a substrate, includes both the composition or the hydrated solid directly or indirectly (e.g., on a primer layer) disposed on (e.g., applied to) the surface or a substrate. Thus, for example, a composition or a hydrated solid disposed on a pre-treatment layer or a primer layer overlying a substrate constitutes a composition or a hydrated solid disposed on the substrate.

The above summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

The complete disclosure of all patents, patent applications, and publications, and electronically available material cited herein are incorporated by reference in their entirety. In the event that any inconsistency exists between the present disclosure and the disclosure(s) of any document incorporated herein by reference, the present disclosure shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

### BRIEF DESCRIPTION OF THE FIGURES

FIG. 1 is a schematic representation of an illustrative matrix at two magnification powers that is consistent with embodiments of the present disclosure.

FIG. 2A is a schematic representation of a short-strand PTFE fibril.

FIG. 2B is a schematic representation of a long-strand PTFE fibril.

FIG. 3A is a schematic representation of a catenated structure of a plurality of active particles around a PTFE fibril of the matrix of FIG. 1.

FIG. 3B is a schematic representation of a conglomerated structure that includes a portion of the plurality of active particles and a portion of the plurality of PTFE fibrils of the matrix of FIG. 1.

FIG. 4 is a flow diagram outlining a first method of making a composition and/or a method of disposing a composition on a substrate, the methods consistent with embodiments of the present disclosure.

FIG. 5 is a flow diagram outlining a second method of making a composition and/or a method of disposing a composition on a substrate, the methods consistent with embodiments of the present disclosure.

FIG. 6 is a flow diagram outlining a method for drying a hydrated solid to form a matrix, the method consistent with embodiments of the present disclosure.

FIG. 7 is a first scanning electron micrograph of a matrix consistent with the present disclosure. The matrix included 40 wt-% K₂CO₃, 8.6 wt-% PTFE-12, and 51.4 wt-% PTFE-E. Image information: working distance (WD)=4.0 mm; 5.0 kV LED; ×11,000.

FIG. 8 is a second scanning electron micrograph of a matrix consistent with the present disclosure. The matrix included 68.9 wt-% CARULITE, 15.5 wt-% PTFE-E, and 15.5 wt-% PTFE-12. Image information: WD=4.9 mm; 5.0 kV LED; ×370.

FIG. 9 is a third scanning electron micrograph of a matrix consistent with the present disclosure. The matrix included 68.9 wt-% CARULITE, 15.5 wt-% PTFE-E, and 15.5 wt-% PTFE-12. Image information: WD=7.5 mm; 5.0 kV LED; ×1,100.

FIG. 10 is a fourth scanning electron micrograph of a matrix consistent with the present disclosure. The matrix included 68.9 wt-% CARULITE, 15.5 wt-% PTFE-E, and 15.5 wt-% PTFE-12. Image information: WD=7.2 mm; 5.0 kV LED; ×3,500.

FIG. 11A-11D show scanning electron micrographs of (11A and 11C) macroscopic coating images and microscopic particle distributions (11B and 11D) for PTFE-10g* (11A and 11B) and PTFE-10 (11C and 11D) media after calcination at 330° C. for 3 h and (11A and 11B) hot pressing at 300° F. (148.9° C.) for 1 h (11C and 11D). Image information for 11B: working WD=7.0 mm; 7.5 kV LED; ×15,000. Image information for 11D: WD=6.9 mm; 7.0 kV LED; ×9,000.

FIG. 12 is a plot showing the ozone destruction rates as a function of downstream bed temperature for different PTFE composite materials under both hot pressing and calcination post-treatment conditions.

FIGS. 13A and 13B show scanning electron micrograph of (13A) PTFE-10g and (13B) CARULTIE-CeO₂/PTFE-10 μm after hot pressing at 300° F. (148.9° C.). Image information for 13A: WD=4.0 mm; 5.0 kV LED; ×6,500. Image information for 13B: WD=4.8 mm; 5.0 kV LED; ×5,000.

FIGS. 14A, 14B, and 14C show scanning electron micrograph of (14A) surface, (14B) K₂CO₃ embedded particles, and (14C) K₂CO₃ conglomerated particles inside a composition comprising long-strand and short-strand PTFE fibrils after vacuum drying. Image information for 14A: WD=3.9 mm; 5.0 kV LED; ×1.00. Image information for 14B: WD=3.9 mm; 5.0 kV LED; ×9,000. Image information for 14C: WD=4.0 mm; 5.0 kV LED; ×11,000.

FIG. 15 shows a scanning electron micrograph of a dewatered cast membrane surface. Image information for 14C: WD=6.6 mm; 7.0 kV LED; ×1,000.

### DETAILED DESCRIPTION OF ILLUSTRATIVE EMBODIMENTS

The present disclosure provides compositions that include a matrix; substrates made from such compositions; substrates with such compositions disposed thereon; methods of making such compositions; and methods of disposing such compositions to substrates. As used herein, the term “composition” includes the matrix alone or the matrix and one or more additional elements of the composition.

The compositions of the present disclosure include a matrix. The matrices of the present disclosure include a plurality of PTFE fibrils and a plurality of active particles. The composition after formation and as a whole are to be understood as in an unstretched state, unless otherwise indicated. One or more of the components of the composition may have been stretched before or during formation of the composition. Stretching generally requires exposure of the composition to a shearing force that is great enough to increase the surface area of the material by two times or more. As used herein, “shearing forces” are unaligned forces acting on a material in different directions (e.g., compression, torsion, tension, etc.). A matrix that is in an unstretched state has not been stretched.

### Plurality of Polytetrafluoroethylene (PTFE) Fibrils

The matrices of the present disclosure include a plurality of PTFE fibrils. A fibril may include a single strand of PTFE or multiple strands of PTFE. In some embodiments, the fibrils are arranged in a fiber configuration; that is, a plurality of ordered PTFE strands generally arranged in the same direction.

The PTFE fibrils are formed from PTFE resin. PTFE resin may include PTFE polymers, oligomers, monomers, or any combination thereof. PTFE resin may be a solid or a liquid. The PTFE resin may be in an emulsion. The PTFE resin includes particles that include the PTFE polymers, oligomers, monomers, or any combination thereof. Each particle of the PTFE resin has a resin particle size. The resin particle size is defined as the greatest distance across a resin particle.

In some embodiments, the plurality of PTFE fibrils are a single species of PTFE fibrils, such as short-strand PTFE fibrils or long-strand PTFE fibrils. In some embodiments, the matrices of the present disclosure include short-strand PTFE fibrils (formed from short-strand PTFE resin) and long-strand PTFE fibrils (formed from long-strand PTFE resin).

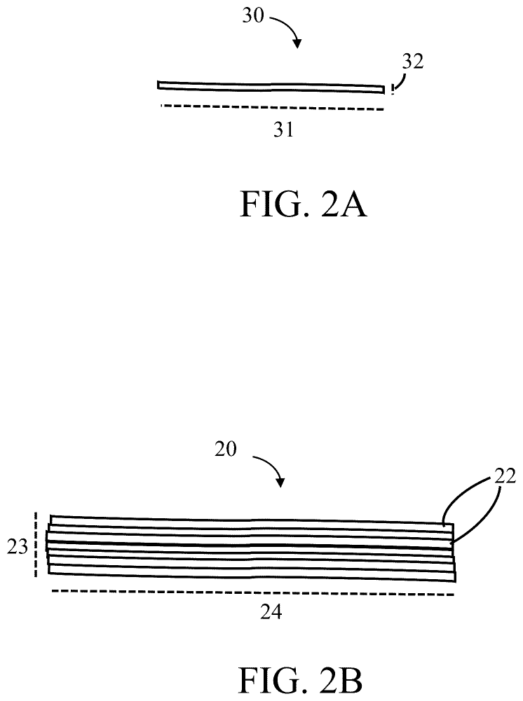

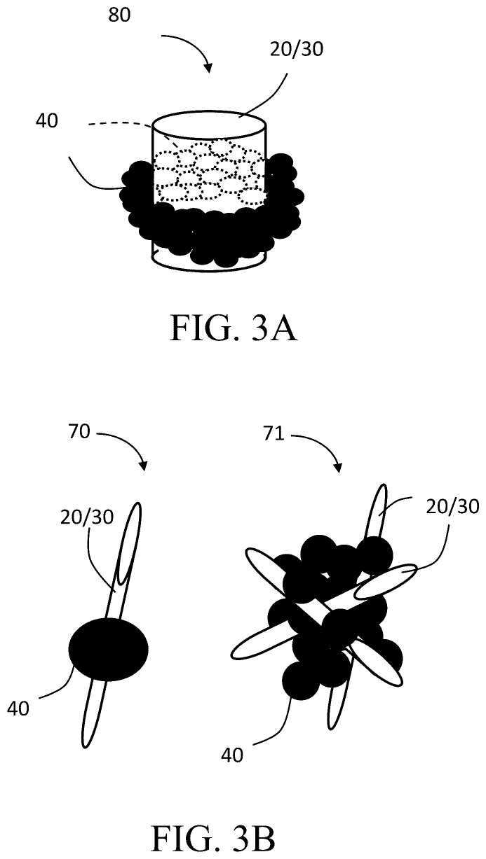

FIG. 2A shows a schematic representation of a short-strand PTFE fibril 30. The short-strand PTFE fibril has a length 31 and a diameter 32. The length of a PTFE fibril (short-strand or long-strand) is the distance spanning the largest dimension of the fibril The diameter of a PTFE fibril (short-strand or long-strand) is the greatest distance spanning the smallest dimension of the fibril

Short-strand PTFE fibrils are formed from short-strand PTFE resin. Short-strand PTFE resin may be obtained or formed as an emulsion with a dispersant (e.g., water and/or an organic solvent) and/or a surfactant. As used herein, the use of short-strand PTFE resin includes the use of resin and/or the use of a short-strand PTFE emulsion with a dispersant and/or a surfactant. In some embodiments, short-strand PTFE resin, such as the PTFE resin used to form the short-strand PTFE fibrils of the matrices of the present disclosure, has an average resin particle size of 1 μm to 9 μm, preferably 3 μm to 5 μm as measured according to the Dimensional Analysis Test Method. Upon incorporation of the short-strand PTFE resin into the matrices of the present disclosure (e.g., using the methods of the present disclosure), the resin particles of the short-strand PTFE resin lengthen (e.g., fibrilizes) to form the short-strand PTFE fibrils.

In some embodiments, the short-strand PTFE fibrils of the matrices have an average length of 30 μm or less (down to 1 μm), preferably 20 μm or less (down to 1 μm), 10 μm or less (down to 1 μm), or 5 μm or less (down to 1 μm) as measured according to the Dimensional Analysis Test Method. In embodiments, the short-strand PTFE fibrils of the matrices have an average length of 30 μm or less (down to 1 μm), preferably 20 μm or less (down to 1 μm), 10 μm or less (down to 1 μm), or 5 μm or less (down to 1 μm) as measured according to the Dimensional Analysis Test Method. In some embodiments, the short-strand PTFE fibrils of the matrices have an average diameter of 0.01 μm or greater, 0.05 μm or greater, 0.3 μm or greater, or 0.5 μm or greater as measured according to the Dimensional Analysis Test Method. In some embodiments, the short-strand PTFE fibrils the matrices have an average diameter of 1 μm or less, 0.5 μm or less, or 0.3 μm or less as measured according to the Dimensional Analysis Test Method.

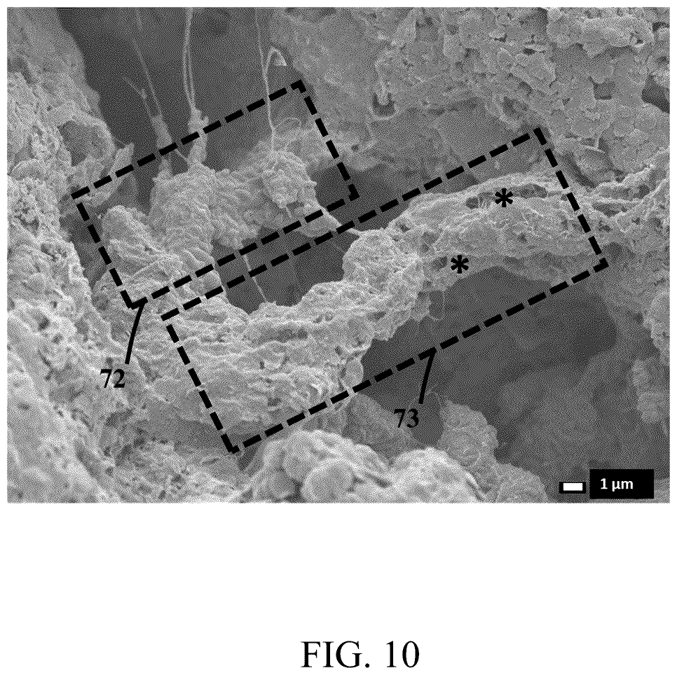

The short-strand PTFE fibrils of the matrices are generally not arranged in an ordered fashion (e.g., see FIG. 8 and discussion elsewhere herein).

FIG. 2B shows a schematic representation of a long-strand PTFE fibril 20. The long-strand PTFE fibril 20 has a diameter 23 and a length 24. In some embodiments, the long-strand PTFE fibril 20 is made up of a plurality of component PTFE fibrils 22. The plurality of component PTFE fibrils 22 are generally aligned in the same direction forming the long-strand PTFE fibril structure. As such, a long-strand PTFE fibril may be thought of as a fiber in that it is made up of component fibrils generally aligned in a singular direction. The plurality of component PTFE fibrils 22 are distinct from short-strand PTFE fibrils for at least the reason that the component PTFE fibrils 22 have an average fibril length that is longer than the average fibril length of short-strand PTFE fibrils. In some embodiments, the long-strand PTFE fibrils (and therefore the component PTFE fibrils) have an average length of 40 μm or greater, 100 μm or greater, 150 μm or greater, 250 μm or greater, 500 μm, 700 or μm or greater, 1000 μm or greater as measured according to the Dimensional Analysis Test Method. In some embodiments, the long-strand PTFE fibrils have an average length of 2000 μm or less, 1000 μm or less, 700 μm or less, 500 μm or less, 250 μm or less, 150 μm or less, or 100 μm or less as measured according to the Dimensional Analysis Test Method. The plurality of component PTFE fibrils 22 do not need to be directly interacting; that is, there may be a space separating two or more of the component PTFE fibrils. Each one of the component PTFE fibrils of the plurality of component PTFE fibrils 22 has a fibril diameter that is thinner than the diameter of the long-strand PTFE fibril 20. The diameter 23 of the long-strand PTFE fibril is the sum of the thickness of each component PTFE fibril and the space (if any) between the component PTFE fibrils. In some embodiments, the average diameter of the long-strand PTFE fibrils is 0.5 μm or greater, 1 μm or greater, 10 μm or greater, or 50 μm or greater. In some embodiments, the average diameter of the long-strand PTFE fibrils is 100 μm or less, 50 μm or less, 10 μm or less, or 1 μm or less as measured according to the Dimensional Analysis Test Method. In some embodiments, the average diameter of the long-strand PTFE fibrils is 0.5 μm to 50 μm, preferably 1 μm to 50 μm, and more preferably 10 μm to 50 μm as measured according to the Dimensional Analysis Test Method.

Long-strand PTFE fibrils are formed from long-strand PTFE resin. In some embodiments, the long-strand PTFE resin has an average resin particle size of 10 μm or greater, 25 μm or greater, 50 μm or greater, 100 μm or greater, 200 μm or greater, 200 μm or greater, and up to 1000 μm as measured according to the Dimensional Analysis Test Method. Upon incorporation of the long-strand PTFE resin into the matrices of the present disclosure (e.g., using the methods of the present disclosure), the particles of the long-strand PTFE resin lengthen (e.g., fibrilizes) to form long-strand PTFE fibrils.

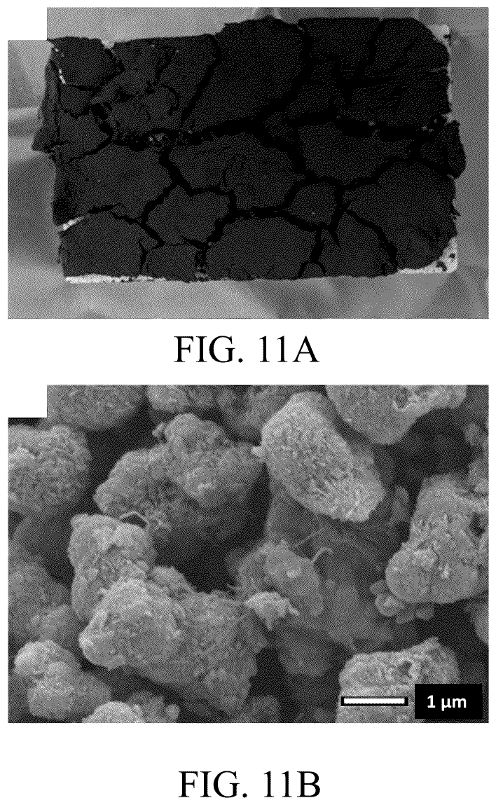

An example of a portion of long-strand PTFE fibril in a matrix of the present disclosure is shown in FIG. 9 in box 30. Without wishing to be bound by theory, it is thought that the long-strand PTFE fibrils may impart some degree of mechanical rigidity to the matrix resulting in a matrix that is membrane-like.

Without wishing to be bound by theory, it is thought that the particles of the short-strand PTFE resin and particles of the long-strand PTFE resin do not merge to form PTFE fibrils; that is, it is thought that particles of the long-strand PTFE resin forms long-strand PTFE fibrils and the particles of the short-strand PTFE resin forms short-strand PTFE fibrils. A short-strand PTFE fibril may be located within a long-strand PTFE fibril; however, they are thought to be separate entities.

The average diameter of the PTFE fibrils, the average length of the PTFE fibrils, and the average resin particle size may be determined using various methods including microscopy, such as scanning electron microscopy (SEM; see the Dimensional Analysis Test Method) or transmission electron microscopy (TEM).

In some embodiments, the compositions of the present disclosure 5 wt-% or greater, 15 wt-% or greater, 25 wt-% or greater, 45 wt-% or greater, 55 wt-% or greater, 65 wt-% or greater, or 80 wt-% or greater of the plurality of PTFE fibrils based on the total weight of the composition and calculated according to the Composition Analysis Test Method. In some embodiments, the composition comprises 95 wt-% or less, 80 wt-% or less, 65 wt-% or less, 55 wt-% or less, 45 wt-% or less, 25 wt-% or less, 15 wt-% or less, or 5 wt-% or less of the plurality of PTFE fibrils based on the total weight of the composition and calculated according to the Composition Analysis Test Method.

The ratio of short-strand PTFE fibrils to long-strand PTFE fibrils in the composition may vary depending on the desired end application of the composition. The ratio and weight percentages of short-strand PTFE fibrils and long-strand PTFE fibrils in the composition are defined as the mass of short-strand PTFE resin and the mass of long-strand PTFE resin used to make the matrix. In some embodiments, the ratio by weight of short-strand PTFE fibrils to long-strand PTFE fibrils may be 5 parts to 1 part short-strand PTFE fibrils for every 0.1 part long-strand PTFE fibrils, preferably 3 parts to 1 part short-strand PTFE fibrils for every 0.1 part long-strand PTFE fibrils.

Stated differently, the total amount of PTFE (i.e., the sum of the short-strand PTFE fibrils and long-strand PTFE fibrils) in the matrix may include varying weight percentages of short-strand PTFE fibrils and long-strand PTFE fibrils. In some embodiments, the composition includes 0.1 wt-% or greater, 1 wt-% or greater, 5 wt-% or greater, 15 wt-% or greater, 25 wt-% or greater, 45 wt-% or greater, 55 wt-% or greater, 65 wt-% or greater, or 80 wt-% or greater of short-strand PTFE fibrils based on the total weight of the composition and calculated according to the Composition Analysis Test Method. In some embodiments, the composition includes 95 wt-% or less, 80 wt-% or less, 65 wt-% or less, 55 wt-% or less, 45 wt-% or less, 25 wt-% or less, 15 wt-% or less, 5 wt-% or less, or 1 wt-% or less of short-strand PTFE fibrils based on the total weight of the composition and calculated according to the Composition Analysis Test Method. In some embodiments, the composition includes 0.01 wt-% or greater, 1 wt-% or greater, 5 wt-% or greater, 10 wt-% or greater, 15 wt-% or greater, 20 wt-% or greater, 30 wt-% or greater, or 40 wt-% or greater of long-strand PTFE fibrils based on the total weight of the composition and calculated according to the Composition Analysis Test Method. In some embodiments, the composition includes 50 wt-% or less, 40 wt-% or less, 30 wt-% or less, 20 wt-% or less, 15 wt-% or less, 10 wt-% or less, 5 wt-% or less, or 1 wt-% or less of the long-strand PTFE fibrils based on the total weight of the composition and calculated according to the Composition Analysis Test Method.

The plurality of PTFE fibrils, or the short-strand PTFE fibrils and the long-strand PTFE fibrils, may include various forms of PTFE such as C3-PTFE, C2-PTFE, C1-PTFE, or any combination thereof. C1-PTFE is a polytetrafluoroethylene polymer that includes the repeating group —(CF₂—C(F)(CF₃))—. C2-PTFE is a polytetrafluoroethylene polymer that includes the —(CF₂—C(F)(CF₂—CF₃))— repeating group. C3-PTFE is a polytetrafluoroethylene polymer that includes the —(CF₂—C(F)(CF₂—CF₂—CF₃))— repeating group. In some cases, it may be desirable to decrease the amount of fluorine in the final composition and/or decrease the amount of fluorine-carbon bonds used in the production of the PTFE. In some embodiments, the PTFE resin used to form the PTFE fibrils, and therefore the PTFE fibrils in the matrix, may include any combination of C1 short-strand PTFE, C2 short-strand PTFE, C3 short-strand PTFE, C1 long-strand PTFE, C2 long-strand PTFE, or C3-long-strand PTFE.

### Plurality Of active Particles

The matrices of the present disclosure include a plurality of active particles. The physical and/or chemical functionality of the particles making up the plurality of active particles may vary based on the intended use of a given matrix or composition comprising such matrix. The plurality of active particles may include a catalyst, a sorbent (e.g., an adsorbent, absorbent, or both), a growth seed, a metal-organic framework, an electroactive material, or any combination thereof.

In some embodiments, the plurality of active particles includes a catalyst. A catalyst is a chemical species that alters the rate of one or more reactions without being consumed. The matrix may include any suitable catalyst, or a combination of catalysts, for facilitating any desired reaction. In some embodiments, desirable reactions may include nitrobenzene reduction, nitrogen oxide (NOₓ) compound reduction, hydrogenation, or any combination thereof. Catalysts that are able to remove, prevent, and/or reduce the emission of harmful gasses into the atmosphere may be of particular interest. For example, the plurality of active particles may include a catalyst capable of reducing and/or converting one or more nitrogen oxide (NOₓ) compounds (e.g., nitric oxide, nitrogen dioxide, dinitrogen trioxide, and/or nitrate) into diatomic nitrogen. The catalysts may be grafted onto a support such as an adsorbent (described elsewhere herein).

In some embodiments, the catalyst is capable of destroying ozone (O₃); that is, the catalyst is able to convert ozone (O₃) to oxygen (O₂) by way of bond rearrangement. Examples of catalysts capable of ozone destruction include silicates such as iron silicates, iron manganese silicates, zinc iron silicates, or any combinations thereof; transition metal oxides such as zinc oxide, manganese oxide, copper oxide, cerium dioxide, or combination thereof; a metal such as a reduced metal (i.e., zero-valent metals) that includes titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof; carbonates such as barium carbonate, magnesium carbonate, calcium carbonate, strontium carbonate, or any combination thereof; zeolites; or any combination thereof. A zeolite is an aluminosilicate compound made up of aluminum, oxygen, silicon, and one or more counterions.

In some embodiments, the catalyst is capable of performing hydrogenation and/or cross-coupling reactions. Such chemical transformations may be useful for small molecule synthesis. Examples of catalysts capable of initiating such reactions include platinum, palladium, rhodium, iridium, PdCl₂, iron, iron oxide, gold, silver, copper, copper oxide, compounds containing the same, and any combination thereof.

In some embodiments, the plurality of active particles include a catalyst capable of ozone destruction that includes manganese oxide (e.g., amorphous manganese oxide), copper oxide, or both. Amorphous materials have little to no crystallinity, which is in contrast to polymorphic materials. An example of an ozone destroying catalyst that includes amorphous manganese oxide is available from Carus LLC (La Salle, IL) under the tradename CARULITE 400. In some embodiments, the plurality of active particles include a catalyst capable of ozone destruction that includes cerium dioxide. In some embodiments, the plurality of active particles includes a catalyst capable of ozone destruction that includes manganese oxide, copper oxide, cerium dioxide, or any combination thereof.

In some embodiments, the active particles include a sorbent. In some embodiments, the sorbent is an adsorbent, an absorbent, or both. Examples of absorbents include cellulose, fumed silica, cotton, natural or synthetic sponge, clays, sodium polyacrylate, sodium alginate, gelatin, and wool.

In some embodiments, the plurality of active particles includes an adsorbent such as a physisorbent, a chemisorbent, a physisorbent-chemisorbent hybrid, or any combination thereof. In some embodiments, the adsorbent is a chemisorbent-physisorbent hybrid. Chemisorbent-physisorbent hybrids include grafted hybrids and impregnated hybrids. A grafted hybrid is a chemisorbent grafted onto a physisorbent or a physisorbent grafted onto a chemisorbent. An impregnated hybrid is a physisorbent impregnated with a chemisorbent or a chemisorbent impregnated with a physisorbent. Grafted hybrids are characterized as a chemisorbent being covalently linked to the physisorbent. Impregnated hybrids are characterized as the chemisorbent being located within the pores of a physisorbent. In impregnated hybrids the chemisorbent is held in the pore via non-covalent interactions (e.g., van der Waals forces). In some embodiments, a graft hybrid or an impregnated hybrid includes one or more of the following physisorbents, activated carbon, a zeolite, a silicate, a metal-organic framework (MOFs), or a mesoporous transition metal oxide.

An adsorbent is a material capable of adsorbing a chemical; that is, the material is capable of isolating a chemical on at least a portion of its surface area. A physisorbent is an adsorbent that isolates a chemical through the formation of weak interactions (e.g., van der Waals and/or electrostatic forces) between the physisorbent and the chemical being adsorbed. A chemisorbent is an adsorbent that isolates a chemical through the formation of an ionic or covalent bond between the chemisorbent and the chemical being adsorbed.

The identity of the adsorbent depends at least in part on the intended use of the composition. Adsorbents may be included that are capable of adsorbing basic compound, an acidic compound, an organic compound, an inorganic compound, or any combination thereof. Such adsorbents may be a physisorbent, a chemisorbent, or a physisorbent-chemisorbent hybrid. The acidic compound, basic compound, organic compound, inorganic compound, or any combination thereof may be in the liquid state, gaseous state and/or vapor state (preferably), or any combination thereof.

In some embodiments, the adsorbent is capable of adsorbing an organic compound in the liquid state, gaseous state and/or vapor state (preferably), or both. An organic compound is a compound that includes at least one carbon-hydrogen covalent bond. Examples of organic compounds that adsorbents can adsorb include aromatic hydrocarbons such as toluene, benzene, xylene, and ethylbenzene; siloxanes; polycyclic aromatic hydrocarbons such as the 16 polycyclic aromatic hydrocarbons classified as priority pollutants by the United States Environmental Protection Agency in 2005 (i.e., naphthalene, acenaphthylene, acenaphthene, fluorene, phenanthrene, anthracene, fluoranthene, pyrene, benz(a)anthracene, chrysene, benzo(b)fluoranthene, benzo(k)fluoranthene, benzo(a)fluoranthene, dibenz(a,h)anthracene, benzo(ghi)perylene, and indeno(1,2,3-cd)pyrene); n-alkanes such as methane, ethane, and n-propane, n-butane, n-pentane, and n-hexane; n-alkenes such as methylene, ethylene, propylene; various alcohols; aldehydes such as formaldehyde, siloxanes; or any combination thereof. Examples of adsorbents capable of adsorbing an organic compound include activated carbon, zeolites (e.g., zeolite X, zeolite A, zeolite Y, zeolite β, and zeolite ZSM-5), silicates, metal-organic frameworks (MOFs), mesoporous transition metal oxides, or any combination thereof.

In some embodiments, the adsorbent is capable of adsorbing an inorganic compound in the liquid state, gaseous state and/or vapor state (preferably), or both. An inorganic compound is a compound that does not have at least one carbon-hydrogen bond. Examples of inorganic compounds that adsorbents can adsorb include carbon dioxide; carbon monoxide; hydrogen sulfide; water: perfluorocarbons such as tetrafluoromethane and hexafluoroethane; nitrogen oxides; sulfur oxides; sulfur hexafluoride; ozone; and any combination thereof. Examples of adsorbents capable of adsorbing one or more inorganic compounds include activated carbon, zeolites (e.g., zeolite X, zeolite A, zeolite Y, zeolite β, and zeolite ZsM-5), silicates, metal-organic frameworks (MOFs), mesoporous transition metal oxides, or any combination thereof. Zeolite physisorbents are an example of an adsorbent capable of adsorbing ozone.

In some embodiments, the adsorbent is capable of adsorbing an acidic compound in liquid state, gaseous state and/or vapor state (preferably), or both. An acidic compound is a compound that when mixed with water at a pH of 7, acidifies the water such that the pH of the resultant solution is below 7. An acidic compound may be an organic or inorganic compound. Examples of acidic compounds that adsorbents can adsorb include sulfur dioxide, nitrogen dioxide, hydrogen sulfide, sulfur trioxide, nitric oxide, or any combination thereof. Examples of adsorbents capable of adsorbing an acidic compound include chemisorbents that include a group I metal (Li, Na, K, Rb, Cs, Fr) carbonate; a metal oxide; a group I (Li, Na, K, Rb, Cs, Fr) metal hydroxide; a group II metal (Be, Mg, Ca, Sr, Ba, Ra) hydroxide; a group II metal (Be, Mg, Ca, Sr, Ba, Ra) oxide; an N-containing compound such as an amine (e.g., tetraethylenepentamine, ethylenediamine and 3-aminopropyltriethoxysilane), an imine (e.g., polyethyleneimine), and an ammonium salt (e.g., ammonium persulfate); or any combination thereof. In some embodiments, the selected chemisorbent may be grafted onto a physisorbent, or impregnated within a physisorbent such as activated carbon; a zeolite; a silicate; or any combination thereof.

In some embodiments, the adsorbent is capable of adsorbing a basic compound in liquid state, gaseous state and/or vapor state (preferably), or both. A basic compound is a compound that when mixed with water at a pH of 7, basifies the water such that the pH of the resultant solution is above 7. A basic compound may be an inorganic compound or an organic compound. Examples of basic compounds that adsorbents can adsorb include ammonia and nitrogen trifluoride. Examples of adsorbents capable of adsorbing a basic compound include physisorbents such as activated carbon, zeolites, silicates, or any combination thereof. Additional examples of adsorbents capable of adsorbing a basic compound include chemisorbents that have a carboxylic acid (COOH) functional group. Examples of chemisorbent compounds that have a carboxylic acid functional group include citric acid, terephthalic acid, trimesic acid, tartaric acid, maleic acid, benzoic acid, oxalic acid, or any combination thereof. Chemisorbents capable of adsorbing a basic compound include inorganic acids such as boric acid, nitric acid, sulfuric acid, hydrochloric acid, hydrogen chloride, hydrogen fluoride, hydrogen bromide, phosphoric acid, perchloric acid, periodic acid, and any combination thereof. Such chemisorbents may be grafted onto or impregnated within a physisorbent such as activated carbon, a zeolite, a silicate, or any combinations thereof.

In some embodiments, the plurality of active particles include a metal-organic framework (MOF). A metal-organic framework (MOF is a compound that includes clusters of metal ions coordinated to organic ligands which form two- or three-dimensional structures. MOFs may be an adsorbent (e.g., physisorbent, chemisorbent, or both), a catalyst, or both. Examples of MOF adsorbents include copper benzene-1,3,5-tricarboxylate (C₁₈H₆Cu₃O₁₂, also known as HKUST-1, Cu-BTC MOF, or MOF-199; available from NOVOMOF in Zofingen, Aargau, Switzerland); zirconium 1,4-dicarboxyenzene MOF (Zr₆O4(OH)₄(dicarboxylate)₆, also known as UiO-66; available from NOVOMOF, Switzerland); zirconium 4,4′-biphenyldicarboxylic acid MOF (Zr₆O₄(OH)₄(4,4′-biphenyldicarboxylic acid)6, also known as UiO-67; available from NOVOMOF, Switzerland); or any combination thereof.

In some embodiments, the plurality of active particles includes a growth seed. The growth seed may serve as the nucleation point for compound, such as a metal-organic framework (MOF). In some such embodiments, the growth seed includes copper nitrate as a growth seed for a copper-based MOF such as copper benzene-1,3,5-tricarboxylate. In some embodiments, the growth seed includes trimesic acid as a growth seed for a copper-based MOF such as copper benzene-1,3,5-tricarboxylate. A growth seed may be reacted with one or more additional reagents prior to, during, or after matrix formation to from an MOF.

In some embodiments, the active particles include an electroactive material. In some embodiments, the electroactive material includes lithium. In some embodiments, the electroactive material includes lithium and one or more metals. Examples of cathode active electroactive material include LiCoO₂, LiFePO₄, LiMn₂O₄, LiNiO₂, Li(NiₓMn_{y}Co_{z})O₂, and Li(NiₓAl_{y}Co_{z})O₂, where x+y+z=1. In some embodiments, the cathode electroactive material is LiCoO₂. In some embodiments, the cathode active electroactive material is LiNiO₂.

In some embodiments, the electroactive material is an anode active compound species. Examples of anode electroactive material include Co₃O₄, Cu₂O, Li₄Ti₅O₁₂ (lithium titanate), SiO₂, Fe₂O₃, Al₃Ni, CuCo₂O₄, PdNiBi, TiO, Sn₄P₃, NiO, carbides thereof, and any combination thereof. Examples of metallic anode materials include Li metal and alkaline earth metals such as Mg or Ca, as well as Si based compounds. The Si based compounds may be in the form of Si fibers. Further examples of anode electroactive species include LiAl alloys, LiSi alloys, LiBi alloys, LiCd alloys, AlMg alloys, LiMg alloys, LiSn alloys, LiSb alloys, FeSn alloys, SnSb alloys, SnCu alloys, LiGe alloys, LiPb alloys, oxides thereof, sulfides thereof, phosphides thereof, carbides thereof, nitrides thereof, and any combination thereof. The molecular formula of an anode electroactive material may not reflect the empirical formula. Additional examples of anode electroactive species include nitrides, oxides, carbides, of metallic or semi-metallic elements including Li, Co, Pd, Pt, W, Mo, Zr, Fe, Al, Ni, Ti, Sn, or any combination thereof. In some embodiments, the anode electroactive material is silicon. In some embodiments, the electroactive material is silicon, and the silicon is in silicon fiber configuration. In some embodiments, the anode electroactive material is Li₄T₁₅O₁₂.

Each particle of the plurality of active particles has a particle size. The particle size is the greatest distance across a particle. The average particle size of the plurality of active particles may vary based on the intended use of the composition and/or the chemical or physical properties of the active particles. The plurality of active particles may have an average particle size of 0.001 μm or greater, 0.01 μm or greater, 0.1 μm or greater, 1 μm or greater, 5 μm or greater, 10 μm or greater, or 100 μm or greater as measured according to the Dimensional Analysis Test Method. The plurality of active particles may have an average particle size of 500 μm or less, 100 μm or less, 10 μm or less, or 1 μm or less as measured according to the Dimensional Analysis Test Method.

Generally, smaller particle sizes may be preferred for particles that include catalysts due to their increased surface area and active site density available for catalyzing reactions. As such, in some embodiments where the plurality of active particles includes a catalyst, the average particle size of the plurality of active particles is 0.001 μm to 5 μm, 0.001 μm to 1 μm, or 0.001 μm to 0.1 μm as measured according to the Dimensional Analysis Test Method. Generally, active particles that include adsorbents with small particle sizes may be preferred as the smaller particle size may allow for larger surface area and greater diffusion. In some embodiments, where the plurality of active particles includes an adsorbent, the average particle size of the particles in the plurality of active particles is 0.001 μm to 100 μm, 1 μm to 100 μm, or 0.001 μm to 0.1 μm as measured according to the Dimensional Analysis Test Method.

The compositions and/or matrices of the present disclosure may have a variety of active particle amounts. The wt-% of active particles (or any individual component of the active particles) in composition and/or matrix may be calculated according to the Composition Analysis Test Methods.

The sum of the wt-% for each component of active particles is considered the wt-% of the active particles that include the components of the active particles. For example, if an active particle includes activated carbon, the amount of the activated carbon is the wt-% of the active particles that include the activated carbon. If an active particle includes manganese oxide and copper oxide, the wt-% of active particles that include the manganese oxide and copper oxide is the sum of the wt-% of manganese oxide and the wt-% of the copper oxide.

The total active particle amount is the sum of the wt-% of the one or more components making up the plurality of active particles in a composition and/or matrix. For example, in embodiments where the active particles include manganese oxide and copper oxide, the total active particle wt-% in a matrix is the sum of the wt-% of the manganese oxide and the wt-% copper oxide. In some embodiments, the total active particle wt- % in a composition and/or matrix is 50 wt-% or greater, 70 wt-% or greater, 80 wt-% or greater, or 90 wt-% or greater by weight of the composition and/or matrix, per the Composition Analysis Test Method. In some embodiments, the total active particle wt-% in the composition and/or matrix is 95 wt-% or less, 90 wt-% or less, 80 wt-% or less, or 70 wt-% or less by weight of the composition and/matrix, per the Composition Analysis Test Method. Stated differently, in some embodiments, the composition and/or matrix incudes 50 wt-% or greater, 70 wt-% or greater, 80 wt-% or greater, or 90 wt-% or greater active particles by weight of the composition and/or matrix, per the Composition Analysis Test Method. In some embodiments, the composition and/or matrix incudes 95 wt-% or less, 90 wt-% or less, 80 wt-% or less, or 70 wt-% or less active particles by the weight of the composition and/or matrix per the Composition Analysis Test Method.

For some uses or a composition and/matrix, it may be beneficial to have low amount of active particles in the composition and/or matrix. In some embodiments, the total active particle wt-% in a composition and/or matrix is 0 wt-% or greater, 0.001 wt-% or greater, 0.01 wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater by weight of the composition and/or matrix, per the Composition Analysis Test Method. In some embodiments, the total active particle wt-% in a composition and/matrix is 20 wt-% of less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less, by weight of the composition and/or matrix, per the Composition Analysis Test Method. Stated differently, in some embodiments, the composition and/or matrix includes 0 wt-% or greater, 0.001 wt-% or greater, 0.01 wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater active particles by weight of the composition and/or matrix, per the Composition Analysis Test Method. In some embodiments, the composition and/or matrix incudes the matrix and/or composition includes 20 wt-% or less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less active particles, by weight of the composition and/or matrix, per the Composition Analysis Test Method.

### Matrices

Compositions of the present disclosure include a matrix. The matrix includes a plurality of PTFE fibrils and a plurality of active particles. In some embodiments, the plurality of PTFE fibrils includes short-strand PTFE fibrils and long-strand PTFE fibrils. The plurality of PTFE fibrils may have any of the chemical and/or physical properties described herein. The plurality of active particles may have any of the chemical and/or physical properties described herein.

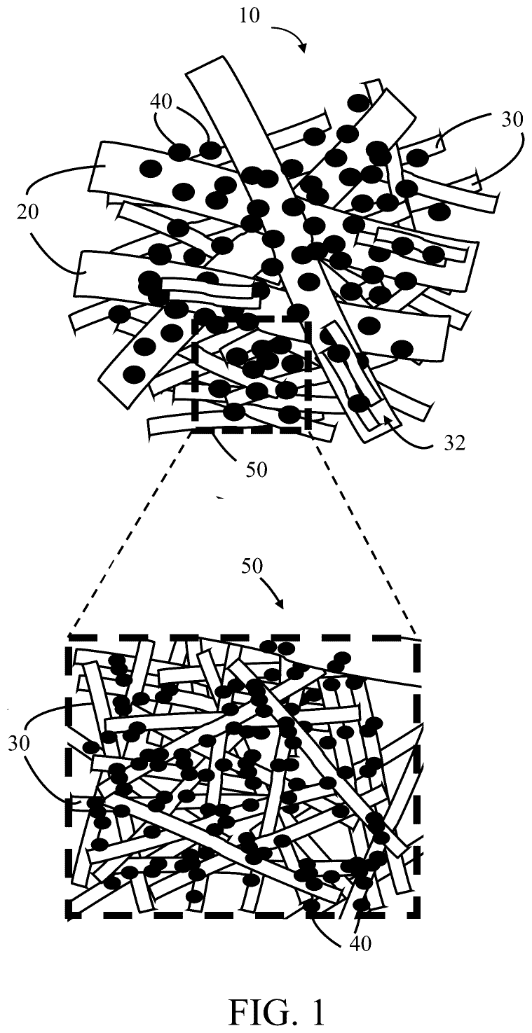

FIG. 1 shows a schematic illustration of a matrix consistent with embodiments of the present disclosure. The matrix 10, includes long-strand PTFE fibrils 20, short-strand PTFE fibrils 30, and a plurality of active particles 40. As described elsewhere herein, the fibrils of the long-strand PTFE fibrils 30 are longer and wider than the fibrils of the short-strand PTFE fibrils 30. The long-strand PTFE fibrils can be observed when the compositions of the present disclosure are imaged at a relatively low magnification (e.g., ×370; see FIG. 8). For example, a portion of a long-strand PTFE fibril can be seen in the SEM image of a matrix consistent with the present disclosure in FIG. 8 (box 21). The component fibrils making up the long-strand PTFE fibril are visible (box 21). In the same figure, unordered short-strand PTFE fibrils can be seen that are distinct from the long-strand PTFE fibril (box 31a, 31b, and 31c). As described elsewhere herein, one or more short-strand PTFE fibrils may be located within a long-strand PTFE fibril 32 (e.g., FIG. 1); however, the short-strand PTFE fibrils and the long-strand PTFE fibril are separate entities. As such, the short-strand PTFE fibrils located within long-strand PTFE fibrils are distinct from the plurality of component fibrils 22 (FIG. 2B) that make up the long-strand PTFE fibril. As discussed elsewhere herein, the component fibrils of the long-strand PTFE fibrils are longer than short-strand PTFE fibrils.

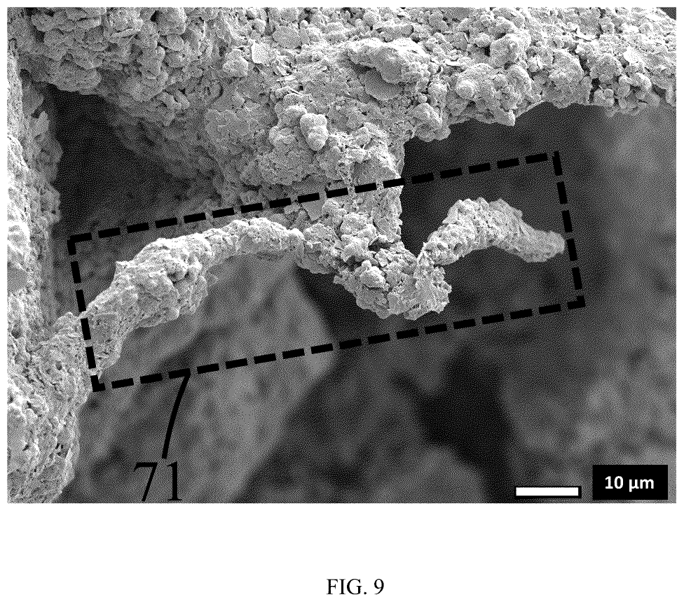

When imaged at a relatively high magnification (e.g., ×9,000; ×7,000; ×11,000; ×20,000), as illustrated in box 50 of FIG. 1, the plurality of small-strand PTFE fibrils have a largely unordered configuration; that is, the fibrils are extending in different directions (e.g., in the x, y, and z directions). This phenomenon can be clearly seen in the SEM image of a matrix consistent with the present disclosure in FIG. 7. Compositions that include only short-strand PTFE fibrils do not include two distinct populations of PTFE fibrils (i.e., short-strand PTFE fibrils and long-strand PTFE fibrils). As discussed, a composition having a single population of PTFE fibrils (e.g., short-strand PTFE fibrils) and a composition having two populations of PTFE fibrils (e.g., short-strand PTFE fibrils and long-strand PTFE fibrils), can be distinguished using microscopy (e.g., scanning electron microscopy).

The plurality of active particles are distributed across the matrix and contact and/or interact with the long-strand PTFE fibrils 20, the short-strand PTFE fibrils 30, or both (FIG. 1). Active particles that are interacting with other active particles, the long-strand PTFE fibrils 20, the short-strand PTFE fibrils 30, or combinations thereof are physically and/or chemically immobilized in the matrix. That is, the term “interaction” refers to a physical force (e.g., frictional force, gravitational force, compression force, tensile force, electrical force, magnetic force, spring force, applied force, and normal force) or a chemical force (e.g., Van der Waals force, Debey force, Keesom force, London dispersion force, dipole-dipole force, hydrogen bonding) between two or more active particles, an active particle and a short-strand PTFE fibril (or multiple short-strand PTFE fibrils), an active particle and a long-strand PTFE fibril (or multiple long-strand PTFE fibrils), or combinations thereof.

The plurality of active particles may have one or more configurations in which they interact with the short-strand PTFE fibrils, the long-strand PTFE fibrils, or both. In some embodiments when the composition has not undergone stretching, at least a portion of the plurality of active particles and at least a portion of the plurality of the PTFE fibrils adopt a catenated structure, a conglomerated structure, or both. In some embodiments, when the composition has not undergone stretching, at least a portion of the plurality of active particles form a catenated structure around one or more short-strand PTFE fibrils, one or more long-strand PTFE fibrils, or both; at least a portion of the plurality of active particles form a conglomerated structure with the one or more short-strand PTFE fibrils, one or more long-strand-PTFE fibrils, or both; or any combination thereof.

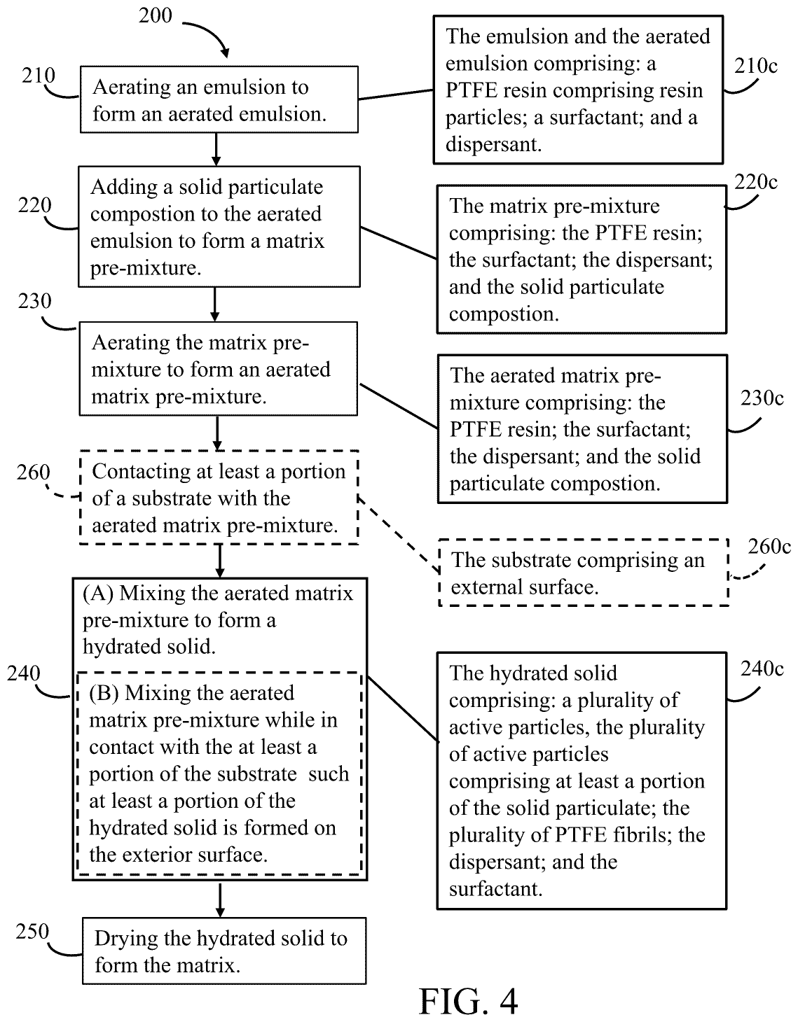

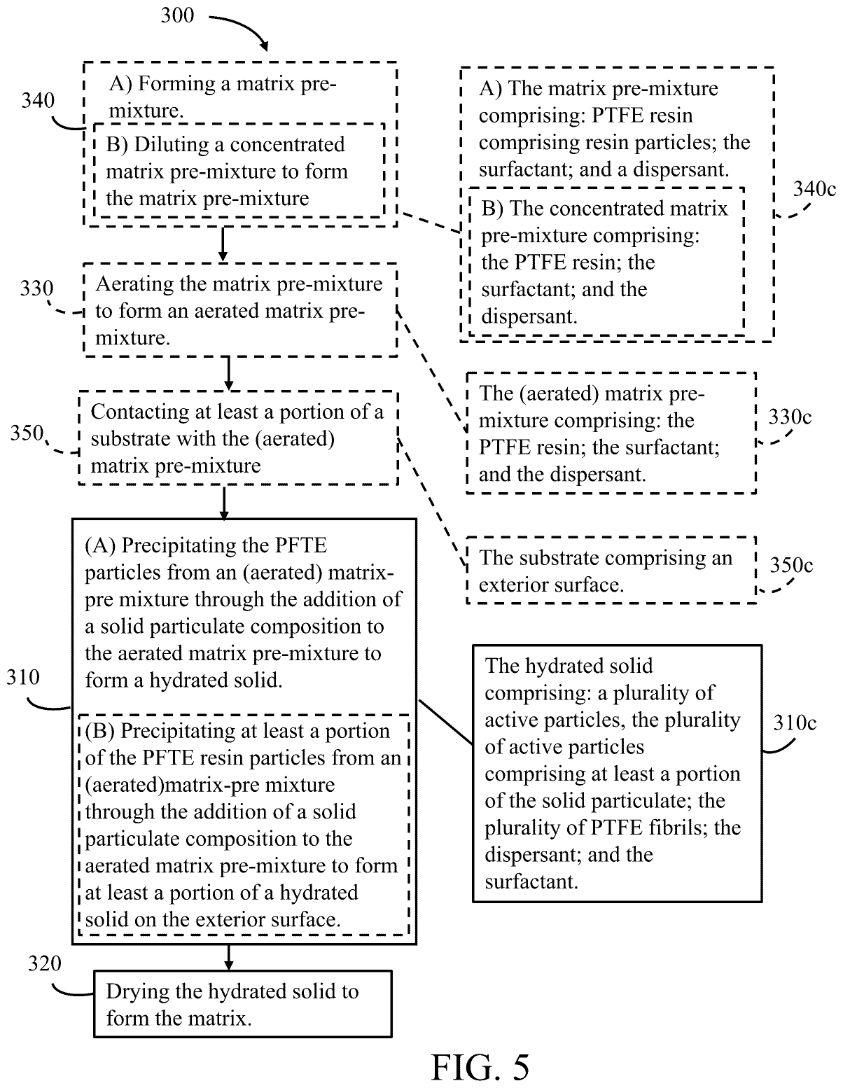

The term “catenated structure” and “catenation structure” are used interchangeably to refer to a self-supporting network of active particles that encapsulate at least a portion of one or more PTFE fibrils. FIG. 3A is a schematic representation of a catenated structure 80. In a catenated structure, a plurality of active particles 40 form a self-supporting network that encapsulates at least a portion of one or more PTFE fibrils 20/30 (e.g., one or more long-strand PTFE fibrils, one or more short-strand PTFE fibrils, or both). While the self-supporting network may be contacting and/or interacting with the one or more PTFE fibrils that it at least partially encapsulates, the primary interaction holding the catenated structure together is the physical interaction between adjacent particles. Without wishing to be bound by theory, it is thought that if the at least partially encapsulated (or entirely encapsulated) PTFE fibril could be removed, the self-supporting network of particles would remain undisturbed. Individual active particles that are involved in a catenated structure may not be well defined because the active particles may merge into one another to create the self-supporting network.

The self-supporting network of active particles can encapsulate a portion of a single PTFE fibril, a portion of multiple PTFE fibrils, an entire PTFE fibril, or the entirety of multiple PTFE fibrils in a catenated structure. The self-supporting network of active particles may encapsulate at least a portion of one or more short-strand PTFE fibrils, at least a portion of one or more long-strand PTFE fibrils, or both in a catenated structure. It is generally thought that catenated structures primarily include the encapsulation of at least a portion of one or more short-strand PTFE fibrils.

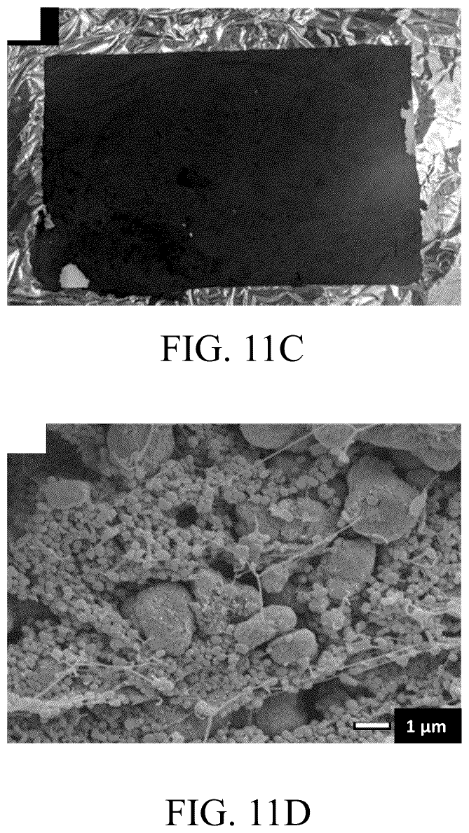

FIG. 9 and FIG. 10 are SEM images of compositions consistent with embodiments of the present disclosure that clearly demonstrate catenated structures as highlighted in boxes 71, 72, and 73. In these images, particles form a self-supporting network, or “bead-like” structure, surrounding one or more PTFE fibrils (e.g., the one or more PTFE fibrils is the string, and the self-supporting network of particles is the bead). The extent of the catenated structure in box 71 is such that the one or more PTFE fibrils cannot be seen (e.g., the PTFE fibril or fibrils are fully encapsulated by the catenated structure). In contrast, in the catenated structures shown in boxes 72 and 73, a portion of the PTFE fibril, or fibrils, involved in the catenated structures are encapsulated within the self-supporting network of active particles. For example, the catenated structures may have gaps in which individual PTFE fibrils can be observed (denoted in FIG. 10 by an *).

Without wishing to be bound by theory, it is thought catenated structures may reduce the likelihood of particle shedding from the composition (e.g., during processing and/or general handling of the matrix or composition containing the matrix). Additionally, it is thought that particles adopting a catenated structure may have a large, exposed surface area due to their spacing and number of exposed faces. This property may increase their activity as catalysts, adsorbents, growth seeds, MOFs, or any combination thereof.

The terms “conglomerated structure” and “conglomeration structure” are used interchangeably to refer to an active particle or an aggregate of active particles that is at least partially held together by one or more PTFE fibrils (e.g., short-strand PTFE fibrils or long-strand PTFE fibrils). In contrast to a catenated structure, the particles of a conglomerated structure do not form a self-supporting network that is generally independent of the PTFE fibrils. In a conglomerated structure, an active particle or aggregate of active particles are held in place through an interaction with one or more PTFE fibrils (e.g., short-strand PTFE fibrils) that extend through (e.g., run through) the particle or aggregate. An aggregate of active particles is a cluster of two or more active particles, each active particle interacting with at least one other active particle of the cluster. In a conglomerated structure that includes an aggregate, the aggregate is held together both through interactions between active particles and interactions between active particles and PTFE fibrils. In contrast to a catenated structure, the active particles of conglomerated structures are generally well defined.

FIG. 3B is a schematic representation of two conglomerated structures 70 and 71 that are consistent with embodiments of the present disclosure. Conglomerated structure 70 is a PTFE fibril from a plurality of PTFE fibrils 20/30 (short-strand PTFE fibril or long-strand PTFE fibril) running through (i.e., interacting with) a single active particle from a plurality of active particles 40. Conglomerated structure 71 is several PTFE fibrils from a plurality of PTFE fibrils 20/30 running through (i.e., interacting with) an aggregate that includes a plurality of active particles 40.

FIG. 7 is an SEM image of a composition consistent with embodiments of the present disclosure that demonstrates various conglomerated structures as highlighted in boxes 81, 82, 83, and 84. Box 81, box 82, and box 83 show a conglomerated structure that has multiple short-strand PTFE fibrils running through an aggregate of active particles. Box 84 shows a conglomerated structure where multiple short-strand PTFE fibrils are running through a single active particle.

Without wishing to be bound by theory, it is thought that conglomerated structures may impart some degree of mechanical stability to at least a portion of the plurality of active particles, at least a portion of the plurality of PTFE fibrils (e.g., long-strand PTFE fibrils, short-strand PTFE fibrils, or both), or both. For example, it is thought that a conglomerated structure may at least partially inhibit one or more of the PTFE fibrils participating in the conglomerated structure from contracting (i.e., decreasing in length). Additionally, conglomerated structures are thought to reduce the likelihood of particle shedding due to the strength imparted by the PTFE fibrils with which the particles of a conglomerated structure are interacting.

### Compositions

The present disclosure provides compositions that include a matrix of the present disclosure. The matrix may be any matrix and/or have any property as described herein.

In some embodiments, the compositions may include one or more additives. Additives may function to increase the processability of the composition. For example, additives may function to increase the mechanical firmness of the composition before and/or after processing; increase retention of the solvent mixture during processing of the composition; improve the rheology and shape retention of the composition during processing; or any combination thereof. Example additives include binders such as kaolinite, bentonite, silicon carbide, fumed silica, zeolites, or any combination thereof. Other exemplary additives include polymers and biopolymers such as poly(vinyl) alcohol (PVA), gelatin, methylcellulose, ethylcellulose, pectin, polyethylene glycol, sodium alginate, agar, xanthan gum, additional PTFE already in the form of fibers, or any combination thereof. The inclusion of a binder may be beneficial to include in compositions that may be used to form honeycomb structures. In some embodiments where the composition includes one or more additives, the total mass of the composition includes 0.1 wt-% or greater, 1 wt-% or greater, or 15 wt-% or greater of the additive based on the total weight of the composition. In some embodiments where the composition includes one or more additives, the total mass of the composition includes 20 wt-% or less, 15 wt-% or less, or 1 wt-% or less of the additive based on the total weight of the composition.

The composition, when in an unstretched state, may have a localized porosity. Localized porosity is the porosity between conglomerated structures and/or catenated structures as determined by analyzing one or more scanning electron micrographs. In some embodiments, the composition, when not stretched, has a localized porosity of at least 10%, at least 20%, or at least 30% as determined according to the Dimensional Analysis Test Method. In some embodiments, the composition, when not stretched, has a localized porosity of 20% or less, 30% or less, 40% or less, or 50% or less as determined according to the Dimensional Analysis Test Method.

In some embodiments, the compositions are processable. As used herein, the term “processable” refers to a material that may be shape engineered; that is, formed into the desired two- or three-dimensional shape. Generally, processable materials have at least one, if not all of the following characteristics: i) well-dispersed phases and/or a homogenous dispersion of particulate before shape processing; ii) pliable but also mechanically firm; iii) not hydrophobic when pressurized (e.g., subject to extrusion); iv) has shape retention after structuring; v) able to retain sufficient solvent for shaping, but not so much as to leach said solvent; and vi) mechanically robust after strengthening (e.g., minimal particle shedding, no visible macroscopic cracking, minimal to no microscopic cracking).

In some embodiments, the composition is processable without contact with a processing aid, such as a fluorinated processing aid (e.g., a fluorinated lubricant). In some embodiments, the composition is processable without screening to form a powder prior to shape engineering. In some embodiments, the composition is processable without the addition of solvent; that is, the composition is processable with only the solvent retained during the process of making the composition. In some embodiments, the composition is a processable putty that can be directly shape engineered.

In some embodiments, and in contrast to many matrices having a single species of PTFE fibrils (e.g., short-strand PTFE fibrils), the matrices of the present disclosure that include both short-strand PTFE fibrils and long-strand PTFE fibrils may be highly processable without the need to form powders prior to shape engineering or the use of processing aids (e.g., fluorinated lubricants and/or solvents) during shape engineering. A processing aid (e.g., an extrusion aid) is a material that is contacted with the composition to facilitate shape engineering. An example of a processing aid a lubricant. A lubricant is a substance that reduces friction between two materials in mutual contact.

In some embodiments, the composition may be cast into a membrane. Such membranes may be further shape engineered, for example, into a web structure, a tape, or a network of nanofibers. A membrane is a pliable sheeting of material suitable for shape engineering. A membrane may be made by casting the components of a composition into a mold.

In some embodiments, the composition may be shape engineered into a web structure. A web structure is an expanded form of the composition having uniform pore size and porosity. A web structure is generally formed by expanding the processable composition in one or more directions, for example, by tentering. Such stretching results in the formation of nodes, that is, locations where multiple fibrils tether to catenated structures and/or conglomerated structures at multiple locations.

In some embodiments, the web structure is embodied as a tape. As used herein, the term “tape” refers to a stretched film that has an increased porosity as compared to the composition prior to stretching. Tapes can be formed by extruding and/or calendering followed by expansion in one or more directions (e.g., tentering) as is known in the field.

In some embodiments, the composition may be shape engineered into a network of nanofibers. The nanofibers include the plurality of PTFE fibrils (e.g., short-strand PTFE fibrils, long-strand PTFE fibrils, or both), and the plurality of active particles. Such networks may be formed by electrospinning the composition. In some such embodiments, the composition may be electrospun with a stabilizing agent such as low strength gelatin, collagen, poly-lactic acid, polyurethane, poly(vinyl) alcohol, nylon, or any combination thereof. Following electrospinning the stabilizing agent is removed (e.g., through calcination) to form the network of nanofibers.

The shape engineered networks of nanofibers may be applied to a substrate.

In some embodiments, the composition is shape engineered into a composite structure such as a honeycomb structure. A “honeycomb structure” refers to a structure with parallel channels that are isolated from one another. Honeycomb structures may be formed by hydraulic-or screw-extrusion techniques as well as 3D printing. Extrusion is the compaction of a material by at least partially removing excess air from the material via passing the material through a constricted opening such that the exit cross section is smaller than the entrance cross section area. In the extrusion techniques, the composition is passed through a pre-machined dye with a set number of cells per a specific cross-sectional surface area. Hydraulic extrusion involves mobilizing the composition by applying an overhead force from a piston to pass the extrudate through the dye. Screw extrusion uses a similar mechanism, but composition mobilization is driven by feeding through a hopper onto a rotating threaded shaft prior to passing the material through the desired dye. 3D printing uses a similar mechanism to extrusion in that an overhead pressure is applied to the composition to pass it through a nozzle tip of a certain diameter, however, the pattern is generated virtually using computer aided design software instead of by pre-machining the geometric properties into an extrudate dye.

In some embodiments, an extrusion aid is used to facilitate extrusion or 3D printing of the composition. A hydrocarbon extrusion aid is a material that may allow for the extrusion process to proceed smoothly and to result in a uniform product. Examples of hydrocarbon extrusion aids include mineral spirits, naphtha, and ISOPAR-K (available from Exxon Mobile, Irving, TX).

In some embodiments, to facilitate shape engineering, the composition may include a binder. In such embodiments, the composition and structure made from shape engineering the composition may include 0.1 wt-% or greater, 1 wt-% or greater, or 3 wt-% or greater of the binder. In some embodiments, the composition and structure made from shape engineering the composition includes 15 wt-% or less, 10 wt-% or less, or 3 wt-% or less of the binder. The binder may be any binder as disclosed elsewhere herein.

### Substrates and Structures

The present disclosure provides structures formed from a composition of the present disclosure and substrates with compositions disposed thereon. Such structures or substrates may be further processed into various materials, such as filter media, membranes, or reactionary surfaces for secondary material coordination. The materials may further be included in filters, may be used as catalytic media for various chemical syntheses in petrochemical or pharmaceutical applications, air intake filters for engine air systems, or may act as destructive catalysts for chemical protection of membrane materials.

Structures formed from the compositions are disclosed. Such structures include a web structure, a tape, a honeycomb structure, a cast membrane, a putty, and a network of nanofibers such as those described elsewhere herein.

In some embodiments where the plurality of active particles includes a catalyst, the composition may be shape engineered into a honeycomb structure. A honeycomb structure may be the preferred structure when the plurality of active particles include a catalyst because the long channels create turbulence that may enhance contact of the reagents with the particles along the walls of the channels which may increase catalytic activity. In certain embodiments where the composition is shape engineered into a honeycomb structure, the composition may include a binder. In such embodiments, the composition used to make the honeycomb structure, and therefore the honeycomb structure itself, may include 0.1 wt-% or greater, 1 wt-% or greater, or 3 wt-% or greater of the binder. In some embodiments, the honeycomb structure may include includes 15 wt-% or less, 10 wt-% or less, or 3 wt-% or less of the binder. A composition used to form a honeycomb structure, and therefore the honeycomb structure itself, may include any suitable binder such as those disclosed elsewhere herein.

In some embodiments where the plurality of active particles include an adsorbent, the composition may be formed into a web structure or a network of nanofibers. The web structure or a network of nanofibers may be further processed and/or include other materials. For example, the web structure or a network of nanofibers may be included in or formed into a filter media.

Substrates that have one or more of the compositions and/or structures formed from the compositions of the present disclosure disposed thereon are disclosed. In some embodiments, structures formed from a composition of the present disclosure are disposed on a substrate. For example, a web structure or a network of nanofibers can be disposed on a substrate.

As used herein, the terms “disposing on” and “disposed on” refer to a composition that is contacting at least a portion of an external surface of a substrate. The composition may be adhered to the at least a portion of the external surface of the substrate. The “external surface” of a substrate is a surface that directly interfaces with the surrounding environment. The external surface may be rough or smooth.

The substrate may be made of any suitable material including nonporous materials. In embodiments where the substrate is nonporous, a composition is disposed on at least a portion of an external surface. Examples of suitable nonporous substrates include corrugated honeycombs such as corrugated steel honeycomb and corrugated aluminum honeycomb; nonporous polyurethane; polyethylene honeycomb; silicon carbide honeycomb; cordierite honeycomb; or any combinations thereof.

### Methods

Methods of making compositions that include a matrix are disclosed. Also disclosed are methods of disposing compositions on substrates. The matrix includes a plurality of PTFE fibrils formed from PTFE resin, and a plurality of active particles. The plurality of PTFE fibrils may include any PTFE composition and have any characteristic as described herein. In some embodiments, the plurality of PTFE fibrils is a single species of fibrils; that is, the plurality of PTFE fibrils is formed from a single species of PTFE resin (e.g., short-strand PTFE fibrils formed from short-strand PTFE resin or long-strand PTFE fibrils formed from long-strand PTFE resin). In some embodiments, the plurality of PTFE fibrils includes short-strand PTFE fibrils and long-strand PTFE fibrils (i.e., the short-strand PTFE fibrils are formed from short-strand PTFE resin and the long-strand PTFE fibrils are formed from long-strand PTFE resin). The plurality of active particles may include any particle and have any characteristic as described herein (e.g., catalyst, adsorbent, metal-organic framework, and/or growth seed). In some embodiments, the composition may be any composition and have any characteristic as described herein.

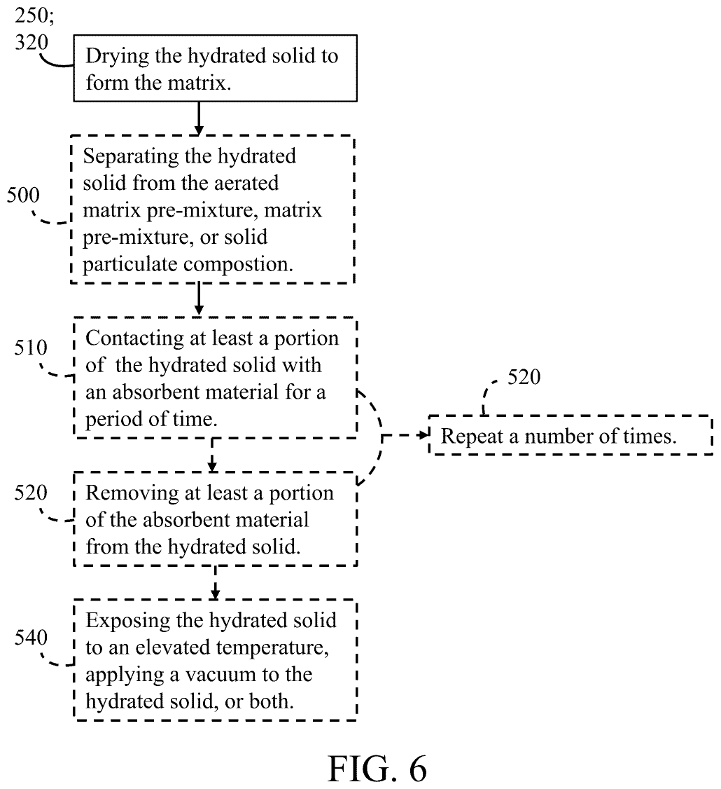

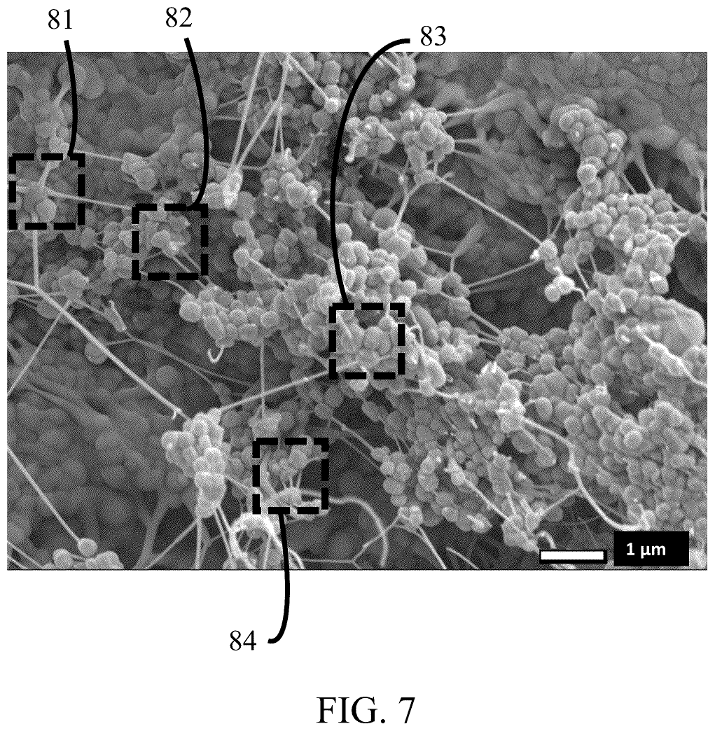

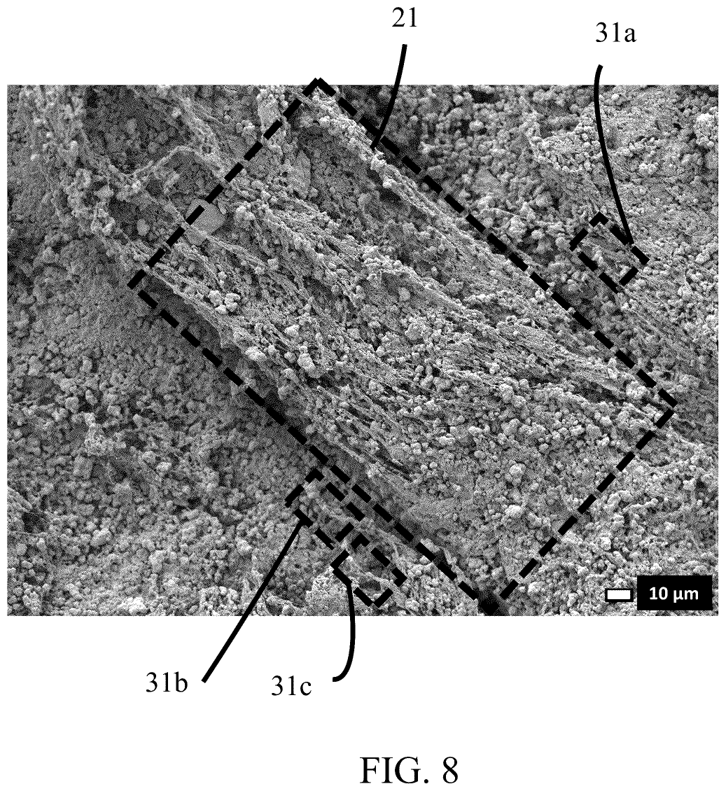

FIG. 4, FIG. 5, and FIG. 6 are flow diagrams showing aspects of illustrative methods disclosed herein. The steps may be conducted in any order. In some embodiments, multiple steps may be conducted at the same time. Steps shown in dashed boxes are optional steps. Each optional step may be performed in a method that includes none or one or more of any additional optional steps (if multiple optional steps are included). For example, a first optional step may be performed in conjunction with one or more additional optional steps; or performed not in conjunction with an additional optional step. Also included in the flow diagrams are boxes directed to the components making up the various composition (e.g., concentrated matrix pre-mixture, matrix pre-mixture, emulsion, aerated emulsion, matrix pre-mixture, (aerated) matrix pre-mixture, hydrated solid, etc.) in the methods. Such boxes have an element number designated with a “c.” It is understood that a component included in a step is also included in any downstream step, with the exception of the drying steps. For example, a dispersant included in a first step is subsequently included in a second step, third step, and so on (including optional steps) until a drying step is completed, in which case the dispersant may be at least partially eliminated during the drying step.

FIG. 4 is a flow diagram outlining a first illustrative method 200 for making a composition that includes a matrix. The matrix includes a plurality of active particles and a plurality of PTFE fibrils formed from PTFE resin (i.e., the resin particles of the PTFE resin).

The method 200 includes aerating an emulsion to form an aerated emulsion at step 210. An emulsion, mixture, or suspension that has been aerated is characterized by the presence of air bubbles and/or air pockets. For example, an aerated emulsion may be characterized as having bubbles on the surface. Aeration may be accomplished using a variety of techniques such as, mechanical shaking, gas injection, bottom-up bubbling, or any combination thereof.

The emulsion (210c) includes PTFE resin, a dispersant, and a surfactant. The surfactant may be any surfactant as described elsewhere herein. The dispersant may be any dispersant as described elsewhere herein. The aerated emulsion (210c) includes the PTFE resin, the dispersant, and the surfactant.

In some embodiments, the method 200, further includes forming the emulsion by diluting a concentrated mixture to form the emulsion (not depicted in FIG. 4). The concentrated mixture includes the PTFE resin and the dispersant. In some embodiments, the concentrated mixture includes at least a portion of the surfactant. In some embodiments, the concentrated mixture includes 60 wt-% PTFE resin (e.g., 60 wt-% short-strand PTFE resin) based on the total weight of the concentrated mixture. In some embodiments, the concentrated mixture is diluted with the dispersant. In some embodiments, the concentrated mixture is diluted with a solution that includes the dispersant and a surfactant. The surfactant may be the same surfactant as in the emulsion or a different surfactant.

The first illustrative method 200 includes adding a solid particulate composition to the aerated emulsion to form a matrix pre-mixture at step 220. The matrix pre-mixture (220c) includes the PTFE resin, the surfactant, the solid particulate composition, and the dispersant. The solid particulate composition comprises a solid particulate. In some embodiments, the solid particulate composition comprises 100 wt-% of the solid particulate (i.e., no other components are included in the solid particulate composition). In some embodiments the solid particulate composition comprises a solid particulate and a liquid carrier. The liquid carrier may include methanol, ethanol, isopropanol, acetone, dimethylformamide, dichloromethane, toluene, ethyl acetate, acetonitrile, dioxane, petroleum ether, dimethyl sulfoxide, tetrahydrofuran, or any combination thereof. In some such embodiments, the solid particulate in the solid particulate composition is dissolved in the liquid carrier. In other embodiments, the solid particulate of the solid particulate composition is suspended in the liquid carrier. In yet other embodiments, a first portion of the solid particulate is dissolved in the liquid carrier and a second portion of the solid particulate is suspended in the liquid carrier.

The plurality of active particles includes at least a portion of the solid particulate. In some embodiments, the solid particulate may be already in the form of the plurality of active particles. In some embodiments, the solid particulate is not in the form of the plurality of active particles. In some such embodiments, at least a portion of the solid particulate becomes the plurality of active particles through aggregation and/or precipitation of the solid particulate.

The amount of solid particulate (included in the solid particulate composition) may vary depending on the identity of the solid particulate and desired end application of the composition. In some embodiments the aerated matrix pre-mixture includes 0.5 wt-% or greater, 10 wt-% or greater, or 30 wt-% or greater of the solid particulate based on the total weight of the aerated matrix pre-mixture. In some embodiments, the aerated matrix pre-mixture includes 50 wt-% or less, 30 wt-% or less, or 10 wt-% or less of the solid particulate based on the total weight of the aerated matrix pre-mixture. In some embodiments, the solid particulate includes potassium carbonate, activated carbon, or both.

The first illustrative method 200 includes aerating the matrix pre-mixture to form an aerated matrix pre-mixture at step 230. Aeration may be accomplished through any means discussed elsewhere herein. The aerated matrix pre-mixture (230c) includes the PTFE resin, the dispersant, the surfactant, and the solid particulate composition.

The first illustrative method 200 includes mixing the aerated matrix pre-mixture to form a hydrated solid at step 240(A). The hydrated solid (240c) includes the plurality of PTFE fibrils, the plurality of active particles, at least a portion of the dispersant, and at least a portion of the surfactant. The plurality of active particles includes at least a portion of the solid particulate. Mixing may be accomplished through a variety of methods including, mechanical rotation (e.g., on a rotating table), mechanical agitation, immersion blending, vibrational agitation, ultrasonic agitation, or any combination thereof. In some embodiments, it may be desirable to use a mixing technique that does not include shearing forces. Using a mixing technique that does not include shearing forces may result in less fibrilization of the PTFE fibrils which, in turn, may impart characteristics to the composition that make it more processable. Mixing may allow for the fibrilization (elongation) of the PTFE resin into PTFE fibrils as well as emulsification of PTFE resin. Mixing may also allow for the active particles to become homogenized within the aerated matrix pre-mixture and to form catenated structures and/or conglomerated structure with the fibrilized and/or fibrilizing PTFE fibrils.

The mixing time may vary depending on the desired application of the composition and/or the identity and/or amount of each component (e.g., the PTFE resin, the surfactant, the solid particulate, and/or any additives) in the aerated matrix pre-mixture. The mixing time may be 10 minutes or greater, 1 hour or greater, 3 hours or greater, or 24 hours or greater. The mixing time may be 48 hours or less, 24 hours or less, 3 hours or less, or 1 hour or less. In some embodiments, the mixing time is 10 minutes to 3 hours, 1 hour to 3 hours, 1 hour to 24 hours, or 3 hours to 24 hours.

The first illustrative method 200 includes drying the hydrated solid to form the matrix at step 250. Drying the hydrated solid includes removing at least a portion of the dispersant and at least a portion of the surfactant from the hydrated solid. Drying may be accomplished to varying extents (i.e., the amount of dispersant, liquid carrier, and/or surfactant may be present in the matrix after drying the hydrated solid) and include various techniques such as those discussed herein (e.g., see the discussion about FIG. 6).

The first illustrative method 200, may be used to dispose a composition on a substrate (e.g., a nonporous substrate) that includes at least one external surface (i.e., exterior surface; 260c). In such cases, the method 200 further includes contacting at least a portion of a substrate with the aerated matrix pre-mixture at step 260. Contacting may be in the form of submerging at least a portion of the substrate in the aerated matrix pre-mixture; pumping the aerated matrix pre-mixture around at least a portion of the substrate; spraying aerosolized aerated matrix pre-mixture on at least a portion of the substrate; or any combination thereof. At least a portion of the substrate is kept in contact with the aerated matrix pre-mixture during the step of mixing the aerated matrix pre-mixture such that at least a portion of the hydrated solid is formed on (e.g., disposed on) at least a portion of the external surface of the substrate at step 240(B). The substrate may be any substrate and have any characteristic as described herein.

In some embodiments of the first illustrative method 200, the plurality of PTFE fibrils of the matrix include short-strand PTFE fibrils formed from short-strand PTFE resin and long-strand PTFE fibrils formed from long-strand PTFE resin. In such embodiments, the PTFE resin of the aerated matrix pre-mixture include short-strand PTFE resin and long-strand PTFE resin. The PTFE resin of the aerated emulsion includes short-strand PTFE resin. The long-strand PTFE resin may be added at any step, or multiple steps, of the method 200 such that the PTFE resin of one or more of the emulsion, aerated emulsion (210c), matrix pre-mixture (220c), or the aerated matrix pre-mixture (230c) include short-strand PTFE resin and long-strand PTFE resin. For example, in some embodiments, the method 200 further includes adding long-strand PTFE resin to the emulsion (prior to aeration) such that the PTFE resin of the emulsion, the PTFE resin of the aerated emulsion (210c), the PTFE resin of the pre-mixture (220c), and the PTFE resin of the aerated pre-mixture (230c) include short-strand PTFE resin and long-strand PTFE resin. In some embodiments, method 200 further includes adding long-strand PTFE resin to the aerated emulsion such that the PTFE resin of the aerated emulsion (210c), the PTFE resin of the pre-mixture (220c), and the PTFE resin of the aerated pre-mixture (230c) include short-strand PTFE resin and long-strand PTFE resin. In some embodiments, method 200 further includes adding long-strand PTFE resin to the matrix pre-mixture such that the PTFE resin of the matrix pre-mixture (220c) and the PTFE resin of the aerated pre-mixture (230c) include short-strand PTFE resin and long-strand PTFE resin. In some embodiments, method 200 further includes adding long-strand PTFE resin to the aerated matrix pre-mixture such that the PTFE resin of the aerated matrix pre-mixture (230c) includes short-strand PTFE resin and long-strand PTFE resin.

In some embodiments of the method 200, the aerated matrix pre-mixture includes 0.01 wt-% or greater, 15 wt-% or greater, 25 wt-% or greater, 45 wt-% or greater, 55 wt-% or greater, or 65 wt-% or greater of the PTFE resin based on the total weight of the aerated matrix pre-mixture. In some embodiments of the method 200, the aerated matrix pre-mixture includes 80 wt-% or less, 65 wt-% or less, 55 wt-% or less, 45 wt-% or less, 25 wt-% or less, or 15 wt-% or less of the PTFE resin based on the total weight of the aerated matrix pre-mixture.

In some embodiments of the method 200, the aerated matrix pre-mixture includes 0.01 wt-% or greater, 1 wt-% or greater, 5 wt-% or greater, or 10 wt-% or greater, of the long-strand PTFE resin based on the total weight of the aerated matrix pre-mixture. In some embodiments of the method 200, the aerated matrix pre-mixture includes 15 wt-% or less, 10 wt-% or less, 5 wt-% or less, or 1 wt-% or less of the long-strand PTFE resin based on the total weight of the aerated matrix pre-mixture.

In some embodiments of the method 200, the aerated matrix pre-mixture includes 0.1 wt-% or greater, 5 wt-% or greater, 15 wt-% or greater, 25 wt-% or greater, 45 wt-% or greater, or 55 wt-% or greater of the short-strand PTFE based on the total weight of the aerated matrix pre-mixture. In some embodiments of the method 200, the aerated matrix pre-mixture includes 70 wt-% or less, 55 wt-% or less, 45 wt-% or less, 25 wt-% or less, 15 wt-% or less, or 5 wt-% or less of the short-strand PTFE resin based on the total weight of the aerated matrix pre-mixture.

FIG. 5 is a flow diagram outlining a second illustrative method 300 for making a composition that includes a matrix. The matrix includes a plurality of active particles and a plurality of PTFE fibrils formed from a PTFE resin (i.e., the resin particles of the PTFE resin). The method 300, is preferably used to make compositions that include a plurality of active particles that includes an absorbent capable of adsorbing a basic compound, an acidic compound, or both. Stated differently, the method 300, is preferably used to make a composition that includes a plurality of particles that include an adsorbent that is acidic, basic, or both.

The method 300 includes precipitating at least a portion of the resin particles of the PTFE resin from an (aerated) matrix pre-mixture through the addition of a solid particulate composition to the aerated matrix pre-mixture to form a hydrated solid at step 310(A). The term “(aerated) matrix pre-mixture” includes a matrix premixture that has been aerated (i.e., an aerated matrix pre-mixture) and a matrix pre-mixture that has not been aerated (i.e., a matrix pre-mixture). The (aerated) matrix pre-mixture (330c) includes PTFE resin, a surfactant, and a dispersant. The surfactant may be any surfactant as disclosed elsewhere herein. The dispersant may be any dispersant as disclosed elsewhere herein. The hydrated solid (310c) includes a plurality of PTFE fibrils formed from the PTFE resin, a plurality of active particles, at least a portion of the dispersant, and at least a portion of the surfactant. The plurality of active particles includes at least a portion of the solid particulate.

The solid particulate composition comprises a solid particulate. In some embodiments, the solid particulate composition comprises 100 wt-% of the solid particulate (i.e., no other components are included in the solid particulate composition). In some embodiments the solid particulate composition comprises a solid particulate and a liquid carrier. The liquid carrier may include methanol, ethanol, isopropanol, acetone, dimethylformamide, dichloromethane, toluene, ethyl acetate, acetonitrile, dioxane, petroleum ether, dimethyl sulfoxide, tetrahydrofuran, or any combination thereof. In some such embodiments, the solid particulate in the solid particulate composition is dissolved in the liquid carrier. In other embodiments, the solid particulate of the solid particulate composition is suspended in the liquid carrier. In yet other embodiments, a first portion of the solid particulate is dissolved in the liquid carrier and a second portion of the solid particulate is suspended in the liquid carrier.

The plurality of active particles includes at least a portion of the solid particulate of the solid particulate composition. In some embodiments, the solid particulate may be already in the form of the plurality of active particles. In some embodiments, the solid particulate is not in the form of the plurality of active particles. In some such embodiments, at least a portion of the solid particulate becomes the plurality of active particles through aggregation and/or precipitation.

The amount of solid particulate added to the (aerated) matrix pre-mixture (added as a solid particulate composition) may vary depending on the identity of the solid particulate and desired end application of the composition. In some embodiments, the amount of solid particulate added to the (aerated) matrix pre-mixture is such that the (aerated) matrix pre-mixture includes 0.5 wt-% or greater, 10 wt-% or greater, or 30 wt-% or greater of the solid particulate based on the total weight of the (aerated) matrix pre-mixture. In some embodiments, the amount of solid particulate added to the (aerated) matrix pre-mixture is such that the (aerated) matrix pre-mixture includes 50 wt-% or less, 30 wt-% or less, or 10 wt-% or less of the solid particulate based on the total weight of the (aerated) matrix pre-mixture. In some embodiments, the solid particulate includes potassium carbonate, activated carbon, or both.

Without wishing to be bound by theory, it is thought that step 310 of method 300 is similar to polymer phase inversion. Polymer phase inversion (sometimes called polymer phase separation) is a de-mixing process by which a dissolved polymer in a solution transfers from a liquid to a solid state. In the conventional sense, a dissolved polymer is partially or fully ionized in an appropriate solvent. Unlike conventional polymer phase inversion, the PTFE in the (aerated) matrix pre-mixture is not dissolved in the sense of being ionized, but rather surfactant reduces the surface tension of the dispersant such that the PTFE can be suspended as a colloid. A colloid is molecularly cohesive (non-ionized) solid that appears as a liquified homogeneous solution. Thus, the mechanism through which the change in pH precipitates the PTFE from the (aerated) matrix pre-mixture is not destabilization of the dissolved polymer since the PTFE is not truly dissolved. Instead, precipitation of the PTFE occurs from destabilization of the surfactant/dispersant system (e.g., or the (aerated) matrix pre-mixture) by way of a pH change through the addition of a solid particulate composition that includes a solid particulate that is acidic or basic. This behavior chemically differs from that of a conventional polymer phase inversion and results in fibrilization of the PTFE resin to form the plurality of PTFE fibrils.

As used herein, the “precipitation” when used in reference to PTFE resin or PTFE fibrils refers to the destabilization of the surfactant/dispersant system resulting in the PTFE resin particles fibrilizing and aggregating together to form a hydrated composition. In the present application, the term precipitation does not imply that the PTFE resin is dissolved in a solution.

The second illustrative method 300 includes drying the hydrated solid to form the matrix at step 320. Drying the hydrated solid includes removing at least a portion of the dispersant and at least a portion of the surfactant from the hydrated solid. Drying may be accomplished to varying extents (i.e., the amount of dispersant, liquid carrier, and/or surfactant present in the matrix after drying) and include various techniques such as those discussed herein (e.g., see the discussion about FIG. 6).

In some embodiments, the second illustrative method 300 includes aerating a matrix pre-mixture to form the aerated matrix pre-mixture at 330. Aeration may be accomplished using techniques described elsewhere herein. The matrix pre-mixture includes the PTFE resin, the surfactant, and the dispersant 330c.

In some embodiments, the second illustrative method 300 includes forming the matrix pre-mixture at 340(A). In some embodiments, the matrix pre-mixture is formed by diluting a concentrated matrix pre-mixture with the dispersant or a solution that includes the dispersant and the surfactant. The concentrated matrix pre-mixture includes the PTFE resin and the dispersant. In some embodiments, the concentrated matrix pre-mixture includes at least a portion of the surfactant. In some embodiments, the concentrated matrix pre-mixture includes 60 wt-% PTFE resin (e.g., 60 wt-% short-strand PTFE resin) based on the total weight of the concentrated matrix pre-mixture. In some embodiments, the mixture is diluted with the dispersant. In some embodiments, the concentrated matrix pre-mixture is diluted with a solution that includes the dispersant and the surfactant.

The second illustrative method 300, may be used to dispose a composition on substrate (350c) that includes at least an external surface (i.e., exterior). In such cases, the method 300 further includes contacting at least a portion of a substrate with the (aerated) matrix pre-mixture at step 350. Contacting may be accomplished using any suitable technique as described herein. At least a portion of the substrate is kept in contact with the (aerated) matrix pre-mixture during the step of precipitating at least a portion of the PTFE resin particles from the (aerated) matrix pre-mixture such that at least a portion of the hydrated solid is formed on (disposed on) at least a portion of the external surface of the substrate at step 310(B). The substrate may be any substrate and have any characteristics as described herein. In some embodiments of the second illustrative method 300, the plurality of PTFE fibrils of the matrix include short-strand PTFE fibrils formed from short-strand PTFE resin and long-strand PTFE fibrils formed from long-strand PTFE resin. In such embodiments, the PTFE resin of the (aerated) matrix pre-mixture (330c(A)) include short-strand PTFE resin and long-strand PTFE resin. The long-strand PTFE resin may be added at any step, or multiple steps, of the method 300 such that the PTFE resin of one or more of the concentrated matrix pre-mixture (340c(B)), the matrix pre-mixture (340c), and the (aerated) matrix pre-mixture (330c) include short-strand PTFE resin and long-strand PTFE resin. For example, in some embodiments, the method 300 further includes adding long-strand PTFE resin to the concentrated matrix pre-mixture such that the PTFE resin of the concentrated matrix pre-mixture (340c(B)), the PTFE resin of the pre-mixture (340c(B)), and the PTFE resin of the (aerated) pre-mixture (330c) include short-strand PTFE resin and long-strand PTFE resin. In some embodiments, the method 300 further includes adding long-strand PTFE resin to the matrix pre-mixture such that the PTFE resin of the matrix pre-mixture (340c(A)) and the PTFE resin of the (aerated) matrix pre-mixture (330c) include short-strand PTFE resin and long-strand PTFE resin. In some embodiments, method 300 further includes adding long-strand PTFE resin to the (aerated) matrix pre-mixture such that the PTFE resin of the (aerated) matrix pre-mixture (330c) includes short-strand PTFE resin and long-strand PTFE resin.

In some embodiments of the method 300, the (aerated) matrix pre-mixture (330c) comprises 0.01 wt-% or greater, 15 wt-% or greater, 25 wt-% or greater, 45 wt-% or greater, 55 wt-% or greater, or 65 wt-% or greater of the PTFE resin based on the total weight of the (aerated) matrix pre-mixture. In some embodiments of the method 300, the (aerated) matrix pre-mixture comprises 80 wt-% or less, 65 wt-% or less, 55 wt-% or less, 45 wt-% or less, 25 wt-% or less, or 15 wt-% or less of the PTFE resin based on the total weight of the (aerated) matrix pre-mixture.

In some embodiments of the method 300, the (aerated) matrix pre-mixture (330c) comprises 0.01 wt-% or greater, 1 wt-% or greater, 5 wt-% or greater, or 10 wt-% or greater, of the long-strand PTFE resin based on the total weight of the (aerated) matrix pre-mixture. In some embodiments of the method 300, the (aerated) matrix pre-mixture comprises 15 wt-% or less, 10 wt-% or less, 5 wt-% or less, or 1 wt-% or less of the long-strand PTFE resin based on the total weight of the (aerated) matrix pre-mixture.

In some embodiments of the method 300, the (aerated) matrix pre-mixture (330c) comprises 0.1 wt-% or greater, 5 wt-% or greater, 15 wt-% or greater, 25 wt-% or greater, 45 wt-% or greater, or 55 wt-% or greater of the short-strand PTFE based on the total weight of the (aerated) matrix pre-mixture. In some embodiments of the method 300, the (aerated) matrix pre-mixture comprise 70 wt-% or less, 55 wt-% or less, 45 wt-% or less, 25 wt-% or less, 15 wt-% or less, or 5 wt-% or less of the short-strand PTFE resin based on the total weight of the (aerated) matrix pre-mixture.

In some embodiments, method 200 and 300 further include extruding the hydrated solid through an extrusion dye to form a composite structure. The composite structure comprises the composition. The hydrated solid may also include isolated pockets of air. Extrusion compacts the hydrated solid through the removal of at least a portion of the air in the hydrated solid. The extrusion dye generally includes an entrance (where composition enters the dye) and an exit (where the composition leaves the dye). The dye may have multiple exits. The cross section of the entrance is larger than the cross section of the exit or exits.

At any time during any one of the methods of the present disclosure, a dispersant may be added to the components of a concentrated matrix pre-mixture, an aerated emulsion, a matrix pre-mixture, an (aerated) matrix pre-mixture, or any combination thereof. In some embodiments, a dispersant may be added before or during a step of any one of the methods disclosed herein. For example, in embodiments where long-strand PTFE resin are added to a concentrated matrix pre-mixture, an emulsion, an aerated emulsion, a matrix pre-mixture, an (aerated) matrix pre-mixture, the long-strand PTFE resin may be added in a mixture that includes a dispersant. The dispersant may be added to dilute the components, suspend the components, facilitate the formation of a colloid that includes one or more components, facilitate the formation of an emulsion, facilitate aeration, or any combination thereof. For example, in some embodiments, a dispersant may be added to the aerated emulsion (e.g., 210c). In some embodiments, a dispersant may be added to the matrix pre-mixture (e.g., 220c, 340c). In some embodiments, a dispersant may be added to the aerated matrix-pre-mixture (e.g., 230c, 330c). In some embodiments, a dispersant may be added to the mixture. In some embodiments, a dispersant may be added to the emulsion (e.g., 210c). In some embodiments, a dispersant is not added to the hydrated solid. In some embodiments, a dispersant is added to the hydrated solid. Methods of the present disclosure include drying the hydrated solid to form the matrix. Drying the hydrated solid includes removing at least a portion of the dispersant and/or liquid carrier (if present) from the hydrated solid. In embodiments where the dispersant comprises water, drying may be referred to as dewatering. Drying the hydrated solid also includes removing at least a portion of the surfactant from the hydrated solid. A composition formed after drying a hydrated solid includes 50 wt-% or less, 20 wt-% or less, 10 wt-% or less, 5 wt-% or less, or 1 wt-% or less of the dispersant and/or liquid carrier (if present) based on the total weight of the composition. A composition formed after drying a hydrated solid includes 50 wt-% or less, 20 wt-% or less, 10 wt-% or less, 5 wt-% or less, or 1 wt-% or less of the surfactant based on the total weight of the composition. The extent of drying may vary depending on the desired application and/or next processing steps of the composition. For example, some dispersant and/or liquid carrier may be useful for shape engineering. As such, in some embodiments, the hydrated solid is dried to an extent such that the composition includes an amount of the dispersant and/or liquid carrier (if present) (e.g., 0.1 wt-% to 50 wt-% water/liquid carrier based on the total weight of the composition) suitable for accomplishing shape engineering without the need for the addition of additional dispersant, liquid carrier, or processing aids such as extrusion aids to the composition.

FIG. 6 is a flow diagram outlining various drying techniques and/or drying method steps. In some embodiments, the hydrated solid is formed such that it is contacting a solution of excess dispersant (and sometimes liquid carrier if present) and surfactant; that is, the hydrated solid crashed out of the (aerated) matrix pre-mixture. In such embodiments, drying the hydrated solid includes separating the hydrated solid from the remaining (aerated) matrix pre-mixture at step 500. This may be accomplished by decanting the (aerated) matrix pre-mixture or physically removing the hydrated solid from the (aerated) matrix pre-mixture.

In some embodiments, drying the hydrated solid includes contacting at least a portion of the hydrated solid (e.g., the external surface of the hydrated solid), preferably the entire hydrated solid (e.g., the entire external surface of the hydrated solid), with an absorbent material. The absorbent material will draw at least a portion of the dispersant, at least a portion of the surfactant, and at least a portion of the liquid carrier (if included) out of the hydrated solid. Any suitable absorbent material may be used. Examples of absorbent materials include cotton; cellulose; a sponge comprising: polyester, polyurethane, vegetal cellulose, melamine, or any combination thereof; anhydrous calcium chloride; anhydrous magnesium sulfate; sodium polyacrylate; or any combination thereof. The hydrated solid may be in contact with the absorbent material for a time. In some embodiments, the contact time is 1 second or greater, 1 minute or greater, or 1 hour or greater. In some embodiments, the contact time is 24 hours or less, 1 hour or less, or 1 min or less. In such embodiments, the method further includes removing at least a portion, preferably all, of the absorbent material from the hydrated solid at step 520.

In some embodiments the hydrated solid is contacted with an absorbent material more than once. Said differently, in some embodiments, the steps of contacting at least a portion of the hydrated solid with the absorbent at step 510 and the step of removing at least a portion of the absorbent material from the hydrated solid at step 520 are consecutively repeated a number of times (e.g., 2 to 10 times, 2 to 20 times, or 2 to 50 times), each time using an absorbent material that had not been previously contacted with the hydrated solid (i.e., a fresh absorbent material).

In some embodiments, drying the hydrated solid further includes exposing the hydrated solid to an elevated temperature for a period of time at step 540. In some embodiments, the hydrated solid is exposed to a temperature of 100° C. to 400° C., preferably 100° C. to 300° C. for 0.1 hour to 24 hours, preferably 1 hour to 5 hours. Preferably, the hydrated solid is not subjected to calcinating conditions. PTFE fibrils may contract at calcinating conditions (e.g., temperatures above 330° C.) which may manifest as broken PTFE fibrils and reduced mechanical stability of the matrix.

In some embodiments, drying the hydrated solid to form the matrix further comprises applying a vacuum to the hydrated solid. In some such embodiments, the hydrated solid is simultaneously exposed to an elevated temperature (e.g., 25° C. to 150° C.).

The dispersant of any one of the illustrative methods may be water, one or more organic solvents, or both. In some embodiments, the dispersant includes water. In some embodiments, the dispersant includes an organic solvent or a mixture of organic solvents. Examples of organic solvent that may be included in a dispersant include, methanol, acetone, tetrahydrofuran, dimethylformamide, acetonitrile, isopropanol, ethanol, ISOPAR-K, or any combination thereof. In some embodiments, the one or more organic solvents include a processing aid such as an extrusion aid. In some embodiments, the extrusion aid includes extrusion mineral spirits or a hydrocarbon solvent such as described elsewhere herein. In embodiments where the dispersant includes an extrusion aid, drying the hydrated solid may include drying the hydrated solid such that the hydrated solid includes a sufficient amount of the extrusion aid for further processing by extrusion. In some embodiments, an extrusion aid may be a lubricant (e.g., ISOPAR-K).

The surfactant of any one of the illustrative methods may be a nonionic nonfluorinated surfactant. A nonionic surfactant is a surfactant that has a polar head group that is not charged. Examples of nonionic nonfluorinated surfactants that may be used include ethoxylates, alkoxylates, and cocamides. In some embodiments the surfactant is polyethylene glycol trimethylnonyl ether. In some embodiments, the (aerated) matrix pre-mixture includes 0.5 wt-% or greater, 5 wt-% or greater, or 20 wt-% or greater of the surfactant based on the total weight of the (aerated) matrix pre-mixture. In some embodiments, the (aerated) matrix pre-mixture includes 40 wt-% or less, 20 wt-% or less, or 5 wt-% or less of the surfactant based on the total weight of the (aerated) matrix pre-mixture. In some embodiments, the (aerated) matrix pre-mixture of any one of the illustrative methods may include 0.5 wt-% to 40 wt-%, preferably 5 wt-% to 20 wt-% of the surfactant based on the total weight of the (aerated) matrix pre-mixture.

The methods of the present disclosure may result in a variety of loading capacities of the plurality of active particles. The loading capacity for each solid particulate (or any individual component of a solid particulate) may be calculated according to the Composition Analysis Test Method (i.e., Loading Capacity Test). The sum of the loading capacity for each component of a solid particulate is considered the loading capacity for the plurality of active particles that include the components of the solid particulate. For example, if a solid particulate includes activated carbon, the loading capacity of the activated carbon is the loading capacity of the plurality of active particles that include the activated carbon. If a solid particulate included manganese oxide and copper oxide, the loading capacity of the plurality of active particles that includes the manganese oxide and copper oxide is the sum of the loading capacity of the manganese oxide and the loading capacity of the copper oxide.

The total active particle loading capacity is the sum of the loading capacity of the one or more components making up the plurality of active particles. For example, in embodiments where the plurality of active particles includes manganese oxide and copper oxide, the total active particle loading capacity is the sum of the loading capacity of the manganese oxide and copper oxide. In some embodiments, the methods of the present disclosure result in a total active particle loading capacity that is 50 wt-% or greater, 70 wt-% or greater, 80 wt-% or greater, or 90 wt-% or greater. In some embodiments, the methods of the present disclosure result in a plurality of active particle loading capacity that is 95 wt-% or less, 90 wt-% or less, 80 wt-% or less, or 70 wt-% or less.

### EXEMPLARY EMBODIMENTS

### Composition Embodiments

Embodiment 1C is a composition comprising: a matrix comprising: a plurality of polytetrafluoroethylene (PTFE) fibrils; and a plurality of active particles.

Embodiment 2C is the composition of embodiment 1C, wherein the plurality of PTFE fibrils comprises short-strand PTFE fibrils and long-strand PTFE fibrils.

Embodiment 3C is the composition of embodiments 1C or 2C, wherein at least a portion of the plurality of active particles and at least a portion of the plurality of the PTFE fibrils adopt a catenated structure, a conglomerated structure, or both, when the composition is in an unstretched state.

Embodiment 4C is the composition of any one of embodiments 1C through 3C, wherein the short-strand PTFE fibrils, the long-strand PTFE fibrils, or both comprise C3-PTFE, C2-PTFE, C1-PTFE, or any combination thereof.

Embodiment 5C is the composition of any one of embodiments 1C through 4C, wherein the plurality of active particles comprises a catalyst, an adsorbent, a growth seed, a metal-organic framework (MOF), an electroactive material, or any combination thereof.

Embodiment 6C is the composition of embodiment 5C, wherein the plurality of active particles comprises a catalyst; and wherein the catalyst is capable of ozone destruction.

Embodiment 7C is the composition of embodiments 5C or 6C, wherein the plurality of active particles comprises a catalyst; and wherein the catalyst is capable of nitrobenzene reduction, hydrogenation, NOx reduction, or any combination thereof.

Embodiment 8C is the composition of embodiment 6C, wherein the plurality of active particles comprises a catalyst; and wherein the catalyst comprises an iron silicate, an iron manganese silicate, a zinc iron silicate, or any combination thereof; a transition metal oxides such as zinc oxide, manganese oxide, copper oxide, cerium dioxide, or a combination thereof; a metals that include titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof; carbonates such as barium carbonate, magnesium carbonate, calcium carbonate, strontium carbonate, or any combination thereof; zeolites; a reduced metal (i.e., zero valent metal) that includes titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof; carbonates such as barium carbonate, magnesium carbonate, calcium carbonate, strontium carbonate, or any combination thereof; or any combination thereof.

Embodiment 9C is the composition of embodiment 5C, wherein the plurality of active particles comprises an adsorbent; and wherein the adsorbent is a physisorbent, a chemisorbant, a physisorbent-chemisorbent hybrid, or any combination thereof.

Embodiment 10C is the composition of embodiment 9C, wherein the plurality of active particles comprises an adsorbent; and wherein the adsorbent is capable of adsorbing basic compound, an acidic compound, an organic compound, an inorganic compound, or any combination thereof. The acidic compound, basic compound, organic compound, inorganic compound, or any combination thereof may be in a liquid state, gaseous and/or vapor state (preferably), or both.

Embodiment 11C is the composition of embodiment 10C, wherein the adsorbent is capable of adsorbing a basic compound; and wherein the basic compound comprises ammonia. The basic compound may be in a liquid state, gaseous and/or vapor state (preferably), or both.

Embodiment 12C is the composition of embodiment 10C, wherein the adsorbent is capable of adsorbing an acidic compound; and wherein the acidic compound comprises sulfur dioxide, nitrogen dioxide, hydrogen sulfide, sulfur trioxide, nitric oxide, or any combination thereof. The acidic compound may be in a liquid state, gaseous and/or vapor state (preferably), or both.

Embodiment 13C is the composition of embodiment 10C, wherein the adsorbent is capable of adsorbing an inorganic compound; and wherein the inorganic compound comprises carbon dioxide; carbon monoxide; water; a nitrogen oxide, a sulfur oxide, hydrogen sulfide; a perfluorocarbon (e.g., tetrafluoromethane and hexafluoroethane); sulfur hexafluoride; ozone; or any combination thereof. The inorganic compound may be in a liquid state, gaseous and/or vapor state (preferably), or both.

Embodiment 14C is the composition of embodiment 10C, wherein the adsorbent is capable of adsorbing an organic compound; and wherein the organic compound comprises an aromatic hydrocarbon (e.g., toluene, benzene, xylene, and ethylbenzene); a siloxane; a polycyclic aromatic hydrocarbon (e.g., naphthalene, acenaphthylene, acenaphthene, fluorene, phenanthrene, anthracene, fluoranthene, pyrene, benz(a)anthracene, chrysene, benzo(b)fluoranthene, benzo(k)fluoranthene, benzo(a)fluoranthene, dibenz(a,h)anthracene, benzo(ghi)perylene, and indeno(1,2,3-cd)pyrene)); an n-alkane (e.g., methane, ethane, propane, butane, pentane, and hexane); an n-alkene (e.g., methylene, ethylene, and propylene); an aldehyde (e.g., formaldehyde); an alcohol; a siloxane; or any combination thereof. The organic compound may be in a liquid state, gaseous and/or vapor state (preferably), or both.

Embodiment 15C is the composition of any one of embodiments 10C through 14C, wherein the adsorbent is a chemisorbant, physisorbent, or a physisorbent-chemisorbent hybrid; and wherein the physisorbent comprises activated carbon, a zeolite, a silicate, a metal-organic framework (MOFs), a mesoporous transition metal oxide, or any combination thereof.

Embodiment 16C is the composition of embodiment 12C, wherein the adsorbent comprises a chemisorbent or a physisorbent-chemisorbent hybrid, and wherein the chemisorbant comprises a group I metal carbonate; a metal oxide; a group I metal hydroxide; a group II metal hydroxide; an N-containing compound such as an amine, an imine, an ammonium salt, or any combination thereof; a carboxylic acid functional group; an inorganic acid; or any combination thereof.

Embodiment 17C is the composition of embodiment 16C, wherein the chemisorbant or the physisorbent-chemisorbent hybrid comprises an N-containing compound; and wherein the N-containing compound comprises polyethyleneimine, tetraethylenepentamine, ethylenediamine, 3-aminopropyltriethoxysilane, or ammonium persulfate.

Embodiment 18C is the composition of embodiment 16C, wherein the chemisorbant or the physisorbent-chemisorbent hybrid comprises a carboxylic acid functional group; wherein an organic acid compound comprises the carboxylic acid functional group; and wherein the organic acid compound comprises citric acid, terephthalic acid, trimesic acid, tartaric acid, maleic acid, benzoic acid, or oxalic acid.

Embodiment 19C is the composition of embodiment 16C, wherein the chemisorbant or the physisorbent-chemisorbent hybrid comprises the inorganic acid; and wherein the inorganic acid comprises boric acid, nitric acid, sulfuric acid, hydrochloric acid, hydrogen chloride, hydrogen fluoride, hydrogen bromide, phosphoric acid, perchloric acid, periodic acid, or any combination thereof.

Embodiment 20C is the composition of any one of embodiments 16C to 19C, wherein the physisorbent-chemisorbent hybrid is according to embodiment 15C.

Embodiment 21C is the composition of embodiment 5C, wherein the plurality of active particles comprises a growth seed; and wherein the growth seed is a nucleation point for the growth of a metal-organic framework (MOF).

Embodiment 22C is the composition of embodiment 21C, wherein the growth seed comprises copper nitrate, trimesic acid, or both.

Embodiment 23C is the composition of embodiment 5C, wherein the plurality of active particles comprises an MOF; and wherein the MOF comprises copper benzene-1,3,5-tricarboxylate.

Embodiment 24C is the composition of embodiment 5C, wherein the plurality of active particles comprises an electroactive material; and wherein the electroactive material is an anode electroactive material, a cathode electroactive material, or both.

Embodiment 25C is the composition of embodiment 5C or 24C, wherein the electroactive material comprises lithium, lithium and one or more metals.

Embodiment 26C is the composition of any one of embodiments 1C through 25C, wherein the plurality of active particles has an average particle size of 0.001 μm or greater, 0.01 μm or greater, 0.1 μm or greater, 1 μm or greater, 5 μm or greater, 10 μm or greater, or 100 μm or greater as measured according to the Dimensional Analysis Test Method. The plurality of active particles has an average particle size of 500 μm or less, 100 μm or less, 10 μm or less, or 1 μm or less as measured according to the Dimensional Analysis Test Method.

Embodiment 27C is the composition of embodiment 26C, wherein the plurality of active particles comprises a catalyst; and wherein the plurality of active particles has an average particle size of 0.001 μm to 5 μm or 0.001 μm to 0.1 μm as measured according to the Dimensional Analysis Test Method.

Embodiment 28C is the composition of embodiment 27C, wherein the plurality of active particles comprises a catalyst; and wherein the plurality of active particles has an average particle size of 0.001 μm to 1 μm as measured according to the Dimensional Analysis Test Method.

Embodiment 29C is the composition of embodiment 26C, wherein the plurality of active particles comprises an adsorbent; and wherein the plurality of active particles has an average particle size of 0.001 μm to 100 μm, 1 μm to 100 μm, or 0.001 μm to 0.1 μm as measured according to the Dimensional Analysis Test Method.

Embodiment 30C is the composition of any one of embodiments 2C through 29C, wherein the short-strand PTFE fibrils has an average length of 30 μm or less, 20 μm or less, 10 μm or less, or 5 μm or less as measured according to the Dimensional Analysis Test Method. The short-strand PTFE fibrils has an average length of 1 μm or greater, 5 μm or greater, 10 μm or greater, or 20 μm or greater as measured according to the Dimensional Analysis Test Method.

Embodiment 31C is the composition of any one of embodiments 2C through 30C, wherein the long-strand PTFE fibrils have an average length of 40 μm or greater, 100 μm or greater, 150 μm or greater, 250 μm or greater, 500 μm or greater , or 1000 μm as measured according to the Dimensional Analysis Test Method. The long-strand PTFE fibrils have an average length of 2000 μm or less, 1000 μm or less, 700 μm or less, 500 μm or less, 250 μm or less, 150 μm or less, or 100 μm or less as measured according to the Dimensional Analysis Test Method.

Embodiment 32C is the composition of embodiments 31C, wherein the long-strand PTFE fibrils has an average length of 40 μm to 700 μm as measured according to the Dimensional Analysis Test Method.

Embodiment 33C is the composition of any one of embodiments 2C through 32C, wherein the short-strand PTFE fibrils has an average diameter of 0.01 μm or greater, 0.05 μm or greater, 0.3 μm or greater, or 0.5 μm or greater as measured according to the Dimensional Analysis Test Method. The short-strand PTFE fibrils has an average diameter of 1 μm or less, 0.5 μm or less, or 0.3 μm or less as measured according to the Dimensional Analysis Test Method.

Embodiment 34C is the composition of any one of embodiments 2C through 33C, wherein the long-strand PTFE fibrils has an average diameter of 100 μm or less, 50 μm or less, 10 μm or less, or 1 μm or less as measured according to the Dimensional Analysis Test Method. The long-strand PTFE fibrils has an average diameter of 0.5 μm or greater, 1 μm or greater, 10 μm or greater, or 50 μm or greater as measured according to the Dimensional Analysis Test Method.

Embodiment 35C is the composition of any one of embodiments 1C through 34C, wherein the composition, when in an unstretched state, has a localized porosity of 10% or greater, 20% or greater, or 30% or greater as measured according to the Dimensional Analysis Test Method. The composition, when in an unstretched state, has a localized porosity of 50% or less, 30% or less, or 20% or less as measured according to the Dimensional Analysis Test Method.

Embodiment 36C is the composition of any one of embodiments 1C through 35C, wherein the composition further comprises an additive.

Embodiment 37C is the composition of embodiment 36C, wherein the additive comprises a binder; and wherein the binder comprises kaolinite, bentonite, silicon carbide, fumed silica, zeolite, or any combination thereof.

Embodiment 38C is the composition of embodiment 36C, wherein the additive comprises a polymer additive.

Embodiment 39C is the composition of any one of embodiments 36C through 38C, wherein the composition comprises 0.1 wt-% or greater, 1 wt-% or greater, or 15 wt-% or greater of the additive based on the total weight of the composition calculated according to the Composition Analysis Test Method. The composition comprises 20 wt-% or less, 15 wt-% or less, or 1 wt-% or less of the additive based on the total weight of the composition calculated according to the Composition Analysis Test Method.

Embodiment 40C is the composition of embodiment 39C, wherein the additive comprises a binder, and wherein the composition comprises 0.1 wt-% or greater, 1 wt-% or greater, or 3 wt-% or greater of the binder calculated according to the Composition Analysis Test Method. The composition includes 15 wt-% or less, 10 wt-% or less, or 3 wt-% or less of the binder calculated according to the Composition Analysis Test Method.

Embodiment 41C is the composition of any one of embodiments 1C through 40C, wherein the composition comprises 5 wt-% or greater, 15 wt-% or greater, 25 wt-% or greater, 45 wt-% or greater, 55 wt-% or greater, 65 wt-% or greater, or 80 wt-% or greater of the plurality of PTFE fibrils based on the total weight of the composition calculated according to the Composition Analysis Test Method. The composition comprises 95 wt-% or less, 80 wt-% or less, 65 wt-% or less, 55 wt-% or less, 45 wt-% or less, 25 wt-% or less, or 15 wt-% or less of the plurality of PTFE fibrils based on the total weight of the composition calculated according to the Composition Analysis Test Method.

Embodiment 42C is the composition of any one of embodiments 2C through 41C, wherein the composition comprises 0.1 wt-% or greater, 1 wt-% or greater, 5 wt-% or greater, 15 wt-% or greater, 25 wt-% or greater, 45 wt-% or greater, 55 wt-% or greater, 65 wt-% or greater, or 80 wt-% or greater of the short-strand PTFE fibrils based on the total weight of the composition calculated according to the Composition Analysis Test Method. The composition comprises 95 wt-% or less, 80 wt-% or less, 65 wt-% or less, 55 wt-% or less, 45 wt-% or less, 25 wt-% or less, 15 wt-% or less, 5 wt-% or less, or 1 wt-% or less of the short-strand PTFE fibrils based on the total weight of the composition calculated according to the Composition Analysis Test Method.

Embodiment 43C is the composition of any one of embodiments 2C through 42C, wherein the composition comprises 0.01 wt-% or greater, 1 wt-% or greater, 5 wt-% or greater, 10 wt-% or greater, 20 wt-% or greater, 30 wt-% or greater, or 40 wt-% or greater of the long-strand PTFE fibrils based on the total weight of the composition calculated according to the Composition Analysis Test Method. The composition comprises 50 wt-% or less, 40 wt-% or less, 30 wt-% or less, 20 wt-% or less, 15 wt-% or less, 10 wt-% or less, 5 wt-% or less, or 1 wt-% or less of the long-strand PTFE fibrils based on the total weight of the composition calculated according to the Composition Analysis Test Method.

Embodiment 44C(i) is the composition of any one of embodiments 1C through 43C, wherein the active particles comprise a total active particle wt-% of the composition and/or matrix and the total active particle wt-% is 50 wt-% or greater, 70 wt-% or greater, 80 wt-% or greater, or 90 wt-% or greater by weight of the composition and/or matrix, per the Composition Analysis Test Method. The total active particle wt-% of the composition and/or matrix is 95 wt-% or less, 90 wt-% or less, 80 wt-% or less, or 70 wt-% or less by weight of the composition and/or matrix, per the Composition Analysis Test Method.

Embodiment 44C(ii) is the composition of any one of embodiments 1C through 43C, wherein the active particles comprise a total active particle wt-% of the composition and/or matrix and the total active particle wt-% is 0 wt-% or greater, 0.001 wt-% or greater, 0.01wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater by weight of the composition and/or matrix, per the Composition Analysis Test Method. The total active particle wt-% of the composition and/or matrix 20 wt-% of less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less, by weight of the composition and/or matrix, per the Composition Analysis Test Method.

Embodiment 45C is the composition of any one of embodiments 1C through 44C, wherein the composition is processable (e.g., into a tape, honeycomb structure, web structure, or membrane) without contact with processing aid.

Embodiment 46C is the composition of any one of embodiments 1C through 44C, wherein the composition is processable (e.g., into a tape, honeycomb structure, web structure, or membrane) without contact with a fluorinated processing aid.

Embodiment 46C is the composition of any one of embodiments 1C through 44C, wherein the composition is processable (e.g., into a tape, honeycomb structure, web structure, or membrane) without first screening the composition into a powder.

### Substrate and Structure Embodiments

Embodiment 1S is the composition of any one of embodiments 1C through 44C, wherein the composition is a putty.

Embodiment 2S is a tape comprising the composition of any one of embodiments 1C through 44C.

Embodiment 3S is a honeycomb structure comprising the composition of any one of embodiments 1C through 44C.

Embodiment 4S is a web structure comprising the composition of any one of embodiments 1C through 44C.

Embodiment 5S is a cast membrane comprising the composition of any one of embodiments 1C through 44C.

Embodiment 6S is a substrate comprising an external surface, the composition of any one of embodiments 1C through 44C disposed on at least a portion of the external surface.

Embodiment 7S is the substrate of embodiments 6S, wherein the substrate comprises a corrugated honeycombs such as corrugated steel honeycomb and corrugated aluminum honeycomb; nonporous polyurethane; polyethylene honeycomb; silicon carbide honeycomb; cordierite honeycomb; or any combination thereof.

### Method Embodiments

Embodiment 1M is a method of making a composition, the composition comprising: a matrix, the matrix comprising: a plurality of PTFE fibrils formed from PTFE resin; and a plurality of active particles; the method comprising: aerating an emulsion to form an aerated emulsion, the emulsion and the aerated emulsion comprising the PTFE resin; a dispersant; and a surfactant; adding a solid particulate composition to the aerated emulsion to form a matrix pre-mixture, the solid particulate composition comprising a solid particulate, the matrix pre-mixture comprising: the PTFE resin; the dispersant; the solid particulate composition; and the surfactant; aerating the matrix pre-mixture to form an aerated matrix pre-mixture, the aerated matrix pre-mixture comprising: the PTFE resin; the solid particulate composition; the dispersant; and the surfactant; mixing the aerated matrix pre-mixture to form a hydrated solid, the hydrated solid comprising: the plurality of PTFE fibrils; the plurality of active particles, the plurality of active particles comprising at least a portion of the solid particulate; at least a portion of the dispersant; and at least a portion of the surfactant; and drying the hydrated solid to form the matrix.

Embodiment 2M is a method of making a composition, the composition comprising: a matrix, the matrix comprising: a plurality of PTFE fibrils formed from PTFE resin; and a plurality of active particles; the method comprising: precipitating at least a portion of the particles of the PTFE resin from an (aerated) matrix pre-mixture through the addition of a solid particulate composition to the (aerated) matrix pre-mixture to form a hydrated solid, the solid particulate composition comprising a solid particulate, the (aerated) matrix pre-mixture comprising: the PTFE resin; a dispersant; and a surfactant; the hydrated solid comprising: the plurality of active particles, the plurality of active particles comprising at least a portion of the solid particulate; at least a portion of the dispersant; and at least a portion of the surfactant; and drying the hydrated solid to form the matrix.

Embodiment 3M is a method of disposing a composition on substrate, the substrate comprising an external surface; the method comprising the method of embodiment 1M or 2M, the method further comprising contacting at least a portion of the external surface of the substrate with the (aerated) matrix pre-mixture such that at least a portion of the hydrated solid is formed on the external surface. In some embodiments, the method further includes mixing the (aerated) matrix pre-mixture while in contact with the at least a portion of the substrate such at least a portion of the hydrated solid is formed on the exterior surface (as dependent on embodiment 1M). In some embodiments, the method further includes precipitating the PFTE particles from the (aerated) matrix-pre mixture through the addition of the solid particulate composition to the (aerated) matrix pre-mixture to form at least a portion of the hydrated solid on the external surface (as dependent on embodiment 2M).

Embodiment 4M is the method of embodiments 1M through 3M, wherein the solid particulate composition further comprises a liquid carrier methanol, ethanol, isopropanol, acetone, dimethylformamide, dichloromethane, toluene, ethyl acetate, acetonitrile, dioxane, petroleum ether, dimethyl sulfoxide, tetrahydrofuran, or any combination thereof.

Embodiment 5M is the method of any one of embodiments 1M to 4M, wherein the composition comprises the composition of any one of embodiments 1C through 44C.

Embodiment 6M is the method of any one of embodiments 3M through 5M, wherein the substrate is a substrate according to embodiment 7S.

Embodiment 7M is the method of any one embodiments 1M through 6M, wherein the solid particulate comprises potassium carbonate, activated carbon, or both.

Embodiment 8M is the method of any one of embodiments 2M through 7M (as dependent on embodiment 2M), further comprising: aerating a matrix pre-mixture to form the (aerated) matrix pre-mixture (in this case an aerated matrix pre-mixture); the matrix pre-mixture comprising: the PTFE resin; the dispersant; and the surfactant.

Embodiment 9M is the method of embodiments 8M, wherein the method further comprises forming the matrix pre-mixture, the matrix pre-mixture comprising the PTFE resin, the surfactant, and the dispersant.

Embodiment 10M is the method of embodiment 9M, wherein the method further comprises diluting a concentrated matrix pre-mixture with the dispersant to form the matrix pre-mixture, the concentrated matrix pre-mixture comprising the PTFE resin, the surfactant, and the dispersant.

Embodiment 11M is the method of any one of embodiments 1M through 10M, wherein the plurality of PTFE fibrils of the matrix comprises: short-strand PTFE fibrils formed from short-strand PTFE resin; and long-strand PTFE fibrils formed from long-strand PTFE resin; and wherein the PTFE resin of the (aerated) matrix pre-mixture comprise short-strand PTFE resin and long-strand PTFE resin.

Embodiment 12M is the method of embodiment 11M, wherein the PTFE resin of the emulsion (as dependent on embodiment 1M), the PTFE resin of the aerated emulsion (as dependent on embodiment 1M), the PTFE resin of the concentrated matrix pre-mixture (as dependent on embodiment 10M), and the PTFE resin of the matrix pre-mixture comprise short-strand PTFE resin.

Embodiment 13M is the method of embodiment 12M (as dependent on embodiment 1M), wherein the method further comprises adding long-strand PTFE resin to the aerated emulsion such that the PTFE resin of the aerated emulsion and the PTFE resin of the matrix pre-mixture further comprise long-strand PTFE resin.

Embodiment 14M is the method of embodiment 12M (as dependent on embodiment 1M), wherein the method further comprises adding long-strand PTFE resin to the emulsion such that the PTFE resin of the emulsion, the PTFE resin of the aerated emulsion, and the PTFE resin of the matrix pre-mixture further comprise long-strand PTFE resin.

Embodiment 15M is the method of embodiment 12M (as dependent on embodiment 1M or 2M), wherein the method further comprises adding long-strand PTFE resin to the matrix pre-mixture such that the PTFE resin of the matrix pre-mixture further comprise long-strand PTFE resin.

Embodiment 16M is the method of embodiment 12M (as dependent on embodiment 1M or 2M), wherein the PTFE resin of the matrix pre-mixture further comprise long-strand PTFE resin.

Embodiment 17M is the method of embodiment 12M (as dependent on embodiment 10), wherein the method further comprises adding long-strand PTFE resin to the concentrated matrix pre-mixture such that the PTFE resin of the concentrated matrix pre-mixture and the PTFE resin of the matrix pre-mixture both further comprise long-strand PTFE resin.

Embodiment 18M is the method of embodiment 12M (as dependent on embodiment 1M), wherein the PTFE resin of the aerated emulsion further comprise long-strand PTFE resin.

Embodiment 19M is the method of embodiment 12M (as dependent on embodiment 1M), wherein the PTFE resin of the emulsion further comprise long-strand PTFE resin.

Embodiment 20M is the method of embodiment 12M (as dependent on embodiment 1M or 2M), wherein the PTFE resin of the matrix pre-mixture further comprises long-strand PTFE resin.

Embodiment 21M is the method of embodiment 12M (as dependent on embodiment 10M) wherein the PTFE resin in the concentrated matrix pre-mixture further comprise long-strand PTFE resin.

Embodiment 22M is the method of any one of embodiments 1M through 21M, wherein after drying, the composition comprises 50 wt-% or less, 25 wt-% or less, 10 wt-% or less, 5 wt-% or less, or preferably 1 wt-% of less dispersant, based on the total weight of the composition.

Embodiment 23M is the method of any one of embodiments 1M through 22M, wherein after drying, the matrix comprises 50 wt-% or less, 20 wt-% or less, 10 wt-% or less, 5 wt-% or less, or 1 wt-% or less surfactant based on the total weight of the composition.

Embodiment 24M is the method of any one of embodiments 1M through 23M, wherein drying the hydrated solid to from the matrix further comprises removing at least a portion of the dispersant, the liquid carrier, the surfactant, or any combination thereof, by contacting at least a portion of the hydrated solid with an absorbent material.

Embodiment 25M is the method of embodiment 24M, wherein the hydrated solid is in contact with the absorbent material for 10 seconds or more, 1 minute or greater, or 1 hour or greater. The hydrated solid is in contact with the absorbent material for 24 hours or less, 1 hour or less, or 1 minute or less.

Embodiment 26M is the method of embodiment 24M or 25M, further comprising removing at least a portion of the absorbent material from contacting the hydrated solid; and repeating the steps of contacting the hydrated solid with the absorbent material and removing at least a portion of the absorbent material from contacting the hydrated solid, a number of times, each time using an absorbent material that had not been previously contacted with the hydrated solid.

Embodiment 27M is the method of any one of embodiments 24M through 26M, wherein the absorbent material comprises cotton; cellulose; a sponge comprising: polyester, polyurethane, vegetal cellulose, melamine, or any combination thereof; anhydrous calcium chloride; anhydrous magnesium sulfate; sodium polyacrylate; or any combination thereof.

Embodiment 28M is the method of any one of embodiments 1M through 27M, wherein drying the hydrated solid to form the matrix further comprises exposing the hydrated solid to an elevated temperature, applying a vacuum to the hydrated solid, or both.

Embodiment 29M is the method of embodiment 28M, wherein drying the hydrated solid to form the matrix further comprises exposing the matrix to a temperature of 100° C. to 400° C., preferably 100° C. to 300° C., for 0.1 hour to 24 hours, preferably 1 hour to 5 hours.

Embodiment 30M is the method of any one of embodiments 1M through 29M, wherein the (aerated) matrix pre-mixture comprises 0.5 wt-% or greater, 10 wt-% or greater, or 30 wt-% or greater of the solid particulate based on the total weight of the (aerated) matrix pre-mixture. The (aerated) matrix pre-mixture comprises 50 wt-% or less, 30 wt-% or less, or 10 wt-% or less of the solid particulate based on the total weight of the (aerated) matrix pre-mixture.

Embodiment 31M is the method of any one of embodiments 2M through 30M (as dependent on embodiment 2M), wherein after the addition of the solid particulate to the (aerated) matrix pre-mixture the (aerated) matrix pre-mixture comprises 0.5 wt-% or greater, 10 wt-% or greater, or 30 wt-% or greater of the solid particulate based on the total weight of the (aerated) matrix pre-mixture. The (aerated) matrix pre-mixture comprise 50 wt-% or less, 30 wt-% or less, or 10 wt-% or less of the solid particulate based on the total weight of the (aerated) matrix pre-mixture.

Embodiment 32M is the method of any one of embodiments 1M through 32M, wherein the (aerated) matrix pre-mixture comprises 0.01 wt-% or greater, 15 wt-% or greater, 25 wt-% or greater, 45 wt-% or greater, 55 wt-% or greater, or 65 wt-% or greater of the PTFE resin based on the total weight of the (aerated) matrix pre-mixture. The (aerated) matrix pre-mixture comprises 80 wt-% or less, 65 wt-% or less, 55 wt-% or less, 45 wt-% or less, 25 wt-% or less, or 15 wt-% or less of PTFE resin based on the total weight of the (aerated) matrix pre-mixture.

Embodiment 33M is the method of any one of embodiments 1M through 11M, or 13M through 32M, wherein the (aerated) matrix pre-mixture comprises 0.01 wt-% or greater, 1 wt-% or greater, 5 wt-% or greater, or 10 wt-% or greater, of the long-strand PTFE resin based on the total weight of the (aerated) matrix pre-mixture. The (aerated) matrix pre-mixture comprises 15 wt-% or less, 10 wt-% or less, 5 wt-% or less, or 1 wt-% or less of the long-strand PTFE resin based on the total weight of the (aerated) matrix pre-mixture.

Embodiment 34M is the method of any one of embodiments 1M through 33M, wherein the (aerated) matrix pre-mixture comprises 0.1 wt-% or greater, 5 wt-% or greater, 15 wt-% or greater, 25 wt-% or greater, 45 wt-% or greater, or 55 wt-% or greater of the short-strand PTFE resin based on the total weight of the (aerated) matrix pre-mixture. The (aerated) matrix pre-mixture comprises 70 wt-% or less, 55 wt-% or less, 45 wt-% or less, 25 wt-% or less, 15 wt-% or less, or 5 wt-% or less of the short-strand PTFE resin based on the total weight of the (aerated) matrix pre-mixture.

Embodiment 35M is the method of any one of embodiments 1M through 34M, wherein the (aerated) matrix pre-mixture comprises 0.5 wt-% or greater, 5 wt-% or greater, or 20 wt-% or greater of the surfactant based on the total weight of the (aerated) matrix pre-mixture. The (aerated) matrix pre-mixture comprises 40 wt-% or less, 20 wt-% or less, or 5 wt-% or less of the surfactant based on the total weight of the (aerated) matrix pre-mixture.

Embodiment 36M is the method of any one of embodiments 1M through 35M, wherein the surfactant comprises a nonionic nonfluorinated surfactant.

Embodiment 37M is the method of embodiment 36M, wherein the surfactant comprises polyethylene glycol trimethylnonyl ether.

Embodiment 38M is the method of any one of embodiments 1M through 37M, wherein the composition is the composition of any one of embodiments 1C through 44C.

Embodiment 39M is the method of any one of embodiments 1M through 38M, wherein the method further comprises extruding the hydrated solid to form a composite structure, the composite structure comprising the composition.

Embodiment 40M is the method of any one of embodiments 1M through 39M, wherein the method results in a total active particle loading capacity that is 50 wt-% or greater, 70 wt-% or greater, 80 wt-% or greater, or 90 wt-% or greater based on the Composition Analysis Test Method (i.e., Loading Capacity Test Method). The methods of the present disclosure results in a total active particle loading capacity that is 95 wt-% or less, 90 wt-% or less, 80 wt-% or less, or 70 wt-% or less based on the Composition Analysis Test Method (i.e., Loading Capacity Test Method).

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, MO; Carus, Peru, IL; Calgon Carbon, Moon Township, PA; Ultramet, Los Angeles, CA; or may be synthesized by conventional methods.

The following abbreviations may be used in the following examples and/or other places in this disclosure: Mn=number average molecular weight; ppm=parts per million; ppb=parts per billion; mL=milliliter; L=liter; LPM=liters per minute; m=meter, mm=millimeter, min=minutes; s=seconds; cm=centimeter, μm=micrometer, kg=kilogram, g=gram, min=minute, s=second, h=hour, ° C.=degrees Celsius, ° F.=degrees Fahrenheit; wt-%=weight percent; M=molar; μM=micromole; mM=millimolar; and DI water=deionized water. Table 1 is a materials table giving a list of components used in the Examples and their associated vendor source, abbreviation, and chemical abstract service (CAS) number.

TABLE 1
Materials and associated information.

| Material | Vendor | Abbreviation | CAS# |
|---|---|---|---|
| CARULTIE 400 | Carus | CARULITE | — |
| (MnO₂) | | | |
| K₂CO₃ (99%) | Sigma-Aldrich | — | 584-08-7 |
| Emulsified | Sigma-Aldrich | PTFE-E | 9002-84-0 |
| Polytetrafluoroethylene | | Surfactant | |
| in water and | | abbreviated as | |
| polyethylene glycol | | PEG-TMNE | |
| trimethylnonyl ether | | | |
| (60% PTFE) | | | |
| Polytetrafluoroethylene | Sigma-Aldrich | PTFE-12 | 9002-84-0 |
| powder (<12 μm) | | | |
| Polytetrafluoroethylene | Chemours | PTFE-601X | — |
| resin (400 μm) | | | |
| Coconut Shell | Calgon | CSAC | EN186 |
| Activated Carbon | | | |
| CeO₂ (<5 μm) | Sigma Aldrich | CeO₂ | 1306-38-3 |
| Reticulated | — | PU-15 | — |
| Polyurethane (15 pores | | | |
| per inch) | | | |
| Reticulated Vitreous | Ultramet | RVC-15 | — |
| Carbon Foam (15 pores | | | |
| per inch) | | | |
| Ethanol (ACS Grade) | Sigma-Aldrich | EtOH | 64-17-5 |
| Distilled Water | In-house | DI | — |
| Gelatin (low strength) | Sigma-Aldrich | — | 9000-70-8 |

### Test Methods

### Ozone Destruction Test

Various iterations of the materials generated for ozone destruction were assessed using the following test method. The samples were subjected to a temperature ramp with air flowrate of 2 liters per minute (2 LPM), ozone generation=2V (TG-10; Ozone solutions), downstream temperature of 80-160° F. (26.6-76.1° C.). The ozone concentration was measured using a Model 202 2B Technologies O₃ detector (available from 2B Technologies in Zurich, Switzerland). A blank experiment under these conditions was performed and the experimental O₃ conversion was calculated from the blank O₃ concentration at each temperature point because the thermal stability of O₃ decreases at elevated temperature. The turnover ratio per catalyst weight was then used to account for changes in catalytic activity stemming from changes in sample mass used for testing. The turnover rate is calculated as follows:

$$Turnover ( \frac{ppb}{{g}_{catalyst} \cdot min} ) = \frac{{C}_{0} - {C}_{t}}{{g}_{c atalyst}}$$

where C₀, Cₜ, and g_{catalyst} being the i) measured blank O₃ concentration at a specific temperature with 2 LPM flow (parts per billion; ppb), ii) measured O₃ concentration at a specific temperature with 2 LPM flow in the catalyst-containing bed (ppb), and iii) weight of catalyst material loaded on the plate (g), respectively.

### Dimensional Analysis

Dimensional analysis and the topography analysis of the various compositions of the examples were accomplished via scanning electron microscopy (SEM) on a JSM-7100F microscope. Prior to imaging the samples, samples were sputter coated for 120 seconds with gold/palladium to prevent charging. Measurements to calculate the average length of long-strand PTFE fibrils, the average resin particle size of long-strand PTFE resin; the average length of short-strand PTFE fibrils; the average resin particle size of short-strand PTFE resin; the average diameter of short-strand PTFE fibrils, the average diameter of long-strand PTFE fibrils; the average particle size of the plurality of active particles; the average particle size of the free active particles; and the average porosity were then taken using ImageJ software. Ten replicate measurements of the lengths/widths/diameters/particle sizes were taken to generate the average for various elements.

### Composition Analysis

The amount of each component in a matrix/composition is calculated according to the following Composition Analysis Test Method. The Composition Analysis Test Method may be referred to as the Loading Capacity Test Method.

The solid loading capacity of the materials after heat treatment was calculated from the initial wetted formulations by assuming homogeneous mixing of the solids and full removal of the water/surfactant mixture. As one example, a matrix was formed from 13.3 g CARULITE, 5 g PTFE-E, and 3 g of PTFE-12 (a total weight of 21.3 g). Knowing that the PTFE-E material was comprised of 60 wt-% PTFE solids as detailed by the manufacturer, the weight of PTFE solids derived thereof was calculated as the product of the weight fraction of PTFE solids and the weight used (e.g., if 5 g of PTFE-E was used, then 60%_{PTFE-Solids}×5 gₑₘᵤₗₛᵢₒₙ₌3 g_{PTFE solids}). The solid content for each component was then calculated on a dry component basis; that is, the calculation did not consider any contribution of the water or surfactant components using the following equation:

$${X}_{i} = \frac{M}{{M}_{1} + {M}_{2} … ++ {M}_{n}} \cdot 100 \%$$

where Xᵢ is the weight percentage of a singular component after drying and Mᵢ is individual mass of the solid component (g) used in the matrix formulation without any solvent. For example, if a composition including 10 g CARULITE, 5 g PTFE-E, and 3 g PTFE-12 were formulated, then the solid fraction of CARULITE could be defined as:

$${X}_{CARULITE} = \frac{10 g ( carulite )}{10 g ( carulite ) + 3 g ( PTFE - 12 ) + 60 \% * 5 g ( PTFE - E )} \cdot 100 \% .$$

Therefore, the composition or matrix included a total wt-% of active particles (CARULITE) or 62.5 wt-%. The composition or matrix also included 18.6 wt-% short-strand PTFE fibrils and 18.6 wt-% long-strand PTFE fibrils. Stated differently, the composition or matrix included 62.5 wt-% active particles and 37.2 wt-% PTFE fibrils.

### Example 1

### A Composition Including Short-Strand PTFE Fibrils, Long-Strand PTFE Fibrils, and Catalysts Particles

A PTFE/CARULITE composite catalyst for ozone destruction was obtained by combining the weight ratios disclosed in Table 2, where the weight ratios referenced therein refer to the wet basis used during mixing. The final dewatered weight bases are shown in Table 3. The PTFE-40 g sample was excluded from Table 3 since it did not generate the necessary conglomeration behavior to form a putty. The materials were processed in the following way. The desired amount of PTFE-E was first measured out by weight and placed into a wide-mouthed Nalgene bottle. A set amount of PTFE-12 was then added to the emulsion (if applicable) to act as a secondary binding agent for mechanical strength, whereafter the slurry was then diluted with 20 mL (20 g) of DI water. The solution was then agitated vigorously by hand shaking to induce frothing which suspended the PTFE-12 particulate. This step was used to achieve a suspension. If no vigorous mixing was done, the PTFE-12 remained as distinctive solid particles.

The solid components were next added to the frothed slurry by first including the CeO₂ (if applicable) followed by the CARULITE 400, where adding the solids released the surface tension from the froth bubbles and shifted the phase back towards that of a homogeneous liquid slurry. An additional 30 mL (30 g) of DI water was also added at this stage to fully suspend the solid particles, whereupon the solution was again vigorously agitated by hand until i) all particulate became homogeneously suspended and ii) a soapy solution was again observed. It was at this stage where the slurry acted as a surface coating - albeit with different particle additives - which is further detailed in subsequent paragraphs.

Following agitation and suspension of the particles, the slurry was rotationally mixed at 30 revolutions per minute (rpm) on a rolling table for 24 h at ambient temperature. After some time, the solids separated from the surfactant/water mixture and formed a coagulated gel-like substance with a small degree of shape retention (agglomeration). The gel was then solidified into a shapeable putty by decanting the separated liquid mixture followed by drying via contact with an absorbent surface. More specifically, the gel was contacted with a cellulose sheet (an absorbent) ten times in 60 second intervals to draw out sufficient moisture content to transition the gel into a shapeable putty with a defined three-dimensional structure capable of self-standing behavior and geometric retention.

TABLE 2
Weight compositions of PTFE/catalyst slurries used to formulate composite materials.

| | PTFE-E | PTFE-12 | CARULITE | CeO₂ | Agglomeration | Post |
|---|---|---|---|---|---|---|
| Sample | (wt. %) | (wt. %) | (wt-%) | (wt-%) | observed (Y/N) | Treatment |
| CARULITE/PTFE-12 | 23.5 | 14.1 | 62.4 | 0.0 | Y | Pressing 300° F., 1 h |
| PTFE-5g | 26.3 | 0.0 | 70.0 | 3.7 | Y | Pressing 300° F., 1 h |
| PTFE-10g | 41.7 | 0.0 | 55.4 | 2.9 | Y | Pressing 300° F., 1 h |
| CARULTIE-CeO₂/PTFE-12 μm | 22.7 | 13.6 | 60.5 | 3.2 | Y | Pressing 300° F., 1 h |
| PTFE-10g | 41.7 | 0.0 | 55.4 | 2.9 | Y | Calcination 626° F., 3 h |
| PTFE-15g | 51.7 | 0.0 | 45.9 | 2.4 | Y | Calcination 626° F., 3 h |
| PTFE-25g | 64.1 | 0.0 | 34.1 | 1.8 | Y | Calcination 626° F., 3 h |
| PTFE-4g | 74.1 | 0.0 | 33.3 | 1.8 | N | — |

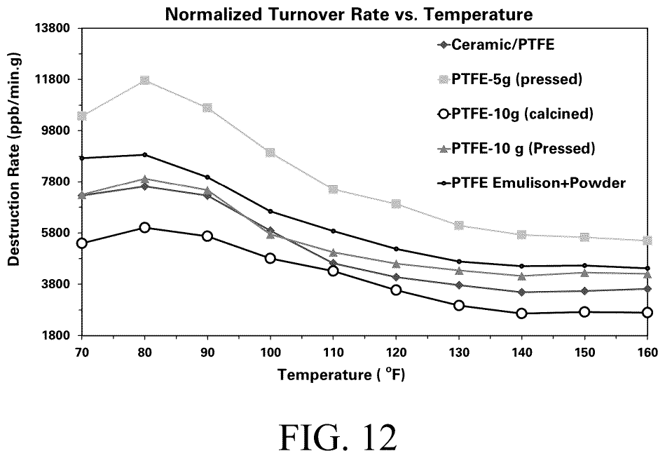

The putty was then applied to an alumina substrate for secondary drying and for use as proof-of-concept testing for ozone destruction. The coated substrates were then dried by one of two methods: either by i) wrapping the material in aluminum foil and pressing it in an Emerson Model 140 Speed Dryer at 300° F. (148.9° C.) for 1 h or by ii) calcining the sample at 330° C. for 3 h. A comparison of the structural integrity and particle dispersions achieved by the two methods is shown in FIG. 11. There was a stark contrast between the two heat treatment methods, as the calcined sample (FIG. 11A) was more prone to macroscopic cracking in the applied layer and generated micron sized conglomerate particles (FIG. 11B), whereas the hot-pressed sample generated a cohesive layer free of macroscopic cracking (FIG. 11C) with smaller nanoscale catalyst particles (FIG. 11D). For clarification, the 10 μm particles in FIG. 11D were determined to be the CeO₂ dopant and not the CARULITE phase. The distinction between the phases prepared by the two techniques arose from PTFE shrinkage at higher temperature in the calcined sample (FIG. 11B), whereas the hot-pressed sample retained fibrillated PTFE web structures and smaller catalyst particulate (FIG. 11D).

TABLE 3
Dried compositions of PTFE composite materials from embodiment one.

| | | | | | Macroscopic |
|---|---|---|---|---|---|
| | | | | | Cracking |
| | PTFE-E | PTFE-12 | CARULITE | CeO₂ | Observed |
| Sample | (wt-%) | (wt-%) | (wt-%) | (wt-%) | (Y/N) |
| CARULITE/PTFE-10 μm | 15.5 | 15.5 | 68.9 | 0.0 | N |
| CARULTIE-CeO₂/ | 15.5 | 15.5 | 66.5 | 3.5 | N |
| PTFE-10 μm | | | | | |
| PTFE-5 g | 17.6 | 0.0 | 78.2 | 4.1 | N |
| PTFE-10 g | 30.0 | 0.0 | 66.5 | 3.5 | N |
| PTFE-10 g* | 30.0 | 0.0 | 66.5 | 3.5 | Y |
| PTFE-15 g | 33.3 | 0.0 | 49.3 | 2.6 | Y |
| PTFE-25 g | 51.7 | 0.0 | 45.9 | 2.4 | Y |

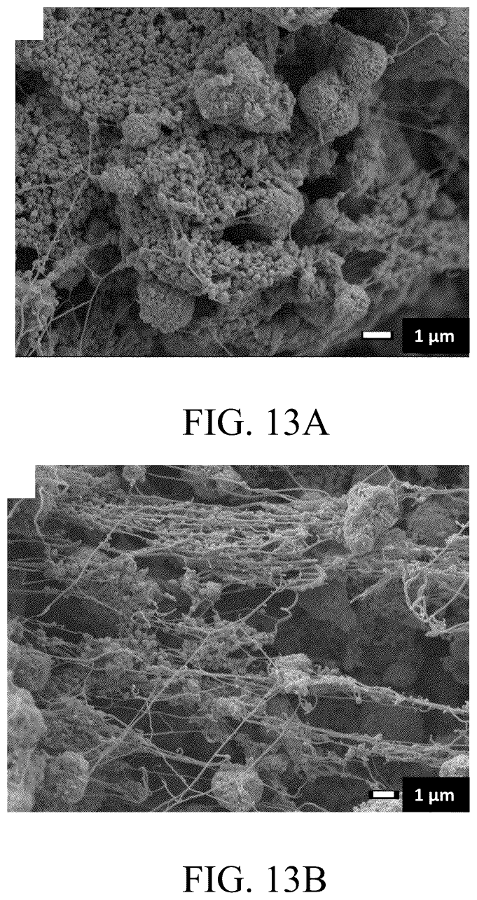

The ozone destruction capabilities as a function of PTFE-E loading and post-treatment method were next screened via thermal sweep tests as described above. As summarized in FIG. 12, the hot-pressed samples outperformed those which were calcined. This better performance in the former was attributed to the retention of nanoscale catalyst particles and a higher active site density as opposed to the conglomerated particles generated via calcination and retraction of the PTFE strands. It was also observed that reducing the amount of PTFE-E used in the slurry further increased performance, which was again attributed to the higher density of active sites in the composite as a result of reduced blockage by the inert PTFE material. Finally, it was observed that the PTFE-10 g (pressed) sample—which was free of PTFE-12—performed slightly worse than the CARULTIE-CeO₂/PTFE-10 μm sample.

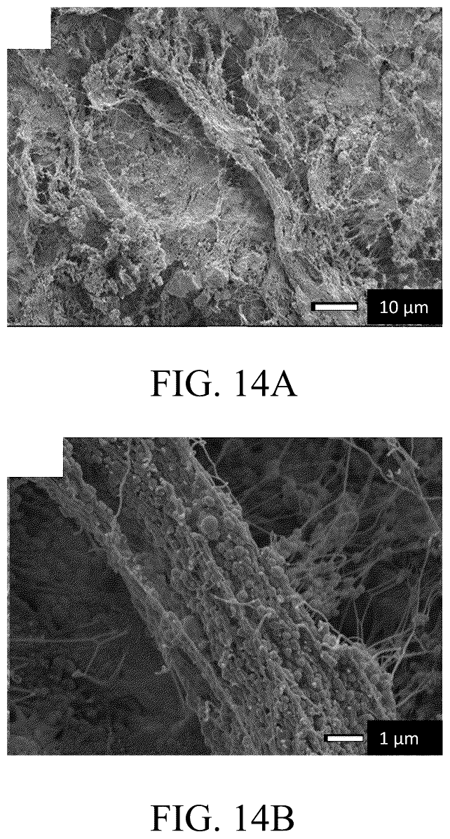

As shown in FIG. 13, these differences were attributed to changes in microstructure between the two media. In particular, using only PTFE-E (FIG. 13A) yielded lesser PTFE fibrillation and more conglomeration within the particle phase, whereas partially supplementing the short chain emulsified PTFE-E with PTFE-12 yielded more fibrillation and more distinctive nanoparticulated catalysts (FIG. 13B). Thus, these findings indicated that the catalytic properties were manipulated by modifying the structural backbone of the putty from formulation.

Building on this and demonstrating the use of dispersants aside from water, an additional coagulant (e.g., composition) was generated using the ratios in Table 4. A similar process to that denoted for production of the water-dispersed coagulants was used here. Briefly, the PTFE-E (5 g) was placed into a Nalgene bottle and 3 g of PTFE-601X was added. The resin mixture was next diluted with 20 mL (13.9 g) of ISOPAR-K and agitated. It was noted that this mixture did not result in emulsification of the PTFE-601X, which was believed to be due to the larger size of the PTFE501X resin particles as opposed to PTFE-12 resin particles. To address this issue, 4.7 g of PEG-TMNE was added to the mixture followed by vigorous agitation. This process did lead to homogeneous emulsification of PTFE-400 in the ISOPAR-K/surfactant solution, as the solids were no longer visible and the colloid became a milky white fluid which is indicative of emulsified PTFE solids. After observing this change, 13.3 g of CARULITE was added to the emulsification, followed by the addition of 15 mL (12.3 g) of ISOPAR-K. The mixture was agitated once more, where it was found to coagulate into an extrudate putty instantly. It should be noted here that there was no distinction between the coagulant and solvent phase by this process, as the putty acted as a solid without separating from its dispersant.

After forming, the coagulant can either be i) left with the surfactant/dispersion mixture indefinitely or ii) partially or fully dried for shape engineering. This behavior differed from the coagulants dispersed with water, which i) required rolling for 24 h to achieve coagulation and ii) displayed a distinctive biphasic distribution of the water and solid putty. Without wishing to be bound by theory, it is believed that the instantaneous solidification and dispersant retention was caused by the wettability of PTFE by ISOPAR-K. Specifically, PTFE is known to be hydrophobic, however, the low surface tension of ISOPAR-K enables it to partially intrude and wet the PTFE solids. Such behavior then destabilizes the surfactant/PTFE matrix rapidly—especially with PTFE-601X—and a homogeneous coagulant is formed. This behavior is believed to be important to extrusion of the putty into solid geometries, as PTFE does not mobilize under hydraulic force easily due to its high shear and non-Newtonian flow behavior, hence an extrusion aid is needed. Typically, such aids are added to the PTFE directly because mixing them with other additives, such as adsorbents or catalysts, without emulsification leads to non-uniformity and a material which cannot be extruded. However, by wetting the PTFE and catalyst together with a dispersant that can act as an extrusion aid—and forming said solids into a homogeneous putty via surfactant/PTFE matrix destabilization—the putty/aid system becomes homogeneous and is therefore extrudable. To this point, it should also be clarified that the putty in Table 4 is intended for extruding into a honeycomb or pellet geometry with compressive ram extrusion. For this reason, the PTFE-12 in earlier examples was replaced with PTFE-601X from Chemours. The reason being that the larger resin diameter of PTFE-601X may enable increased binding with both the PTFE-E resin solids as well as the CARULITE phase. The longer stands may enable better enable polymer-polymer interactions, thus rendering the extruded structure more mechanically stable.

TABLE 4
Weight composition of ISOPAR-K dispersed
composite before and drying.

| CARULITE | PTFE-E | PTFE-601X | ISOPAR-K | PEG-TMNE | Dried |
|---|---|---|---|---|---|
| (wt-%) | (wt-%) | (wt-%) | (wt-%) | (wt-%) | (Y/N) |
| 25.5 | 9.6 | 5.8 | 32.5 | 23.6 | N |
| 68.9 | 15.5 | 15.5 | 0.0 | 0.0 | Y |

### Example 2

### A Composition Including Short-Strand PTFE Fibrils, Long-Strand PTFE Fibrils, and an Adsorbent

The second example refers to a base- or acid-initiated surfactant destabilization of emulsified PTFE as a means of generating a functionalized conglomerate of fibrillated fluoropolymer and solidified initiators. The composite material can then be used as a medium for secondary growth of functional materials—such as metal-organic frameworks—or adsorption applications. The material was generated by first pouring 30 mL of PTFE-E and 3 g of PTFE-12 into a beaker. The mixture was sonicated for 10 min at ambient temperature until homogeneity was observed and no PTFE-12 particles remained. An initiator for surfactant destabilization—in this case 14 g of K₂CO₃—was then added to the suspension, which caused precipitation of a white solid that absorbed all remaining liquid. The precipitating behavior observed by this method was similar to that of polymer phase inversion, however, the emulsified PTFE solids were not dissolved in a typical dissociative sense within a solvent. Rather, the PTFE was emulsified so it retained its full chemical structure and therefore acted more as uniform solids within a surfactant/water mixture which did not undergo a dissociative change. Hence, phase inversion by way of a basic- or acidic-initiator as ascribed in this example differed from that of conventional polymer phase inversion since it stemmed from a pH-driven destabilization of the surfactant and not a change in solubility of the polymer, itself.

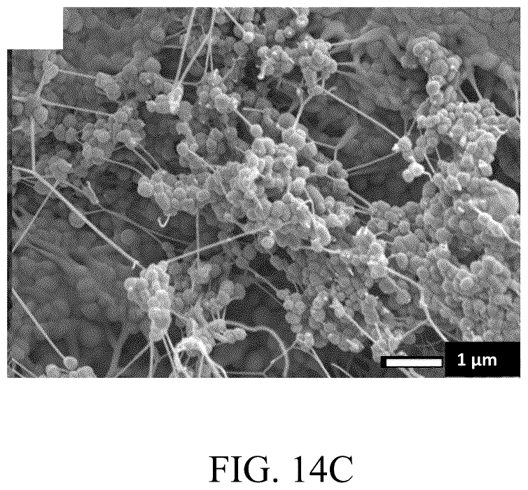

The precipitate was transformed into a dried and shapeable solid by fully drying the material. Unlike Example 1, the precipitate here was dried via evacuation in a vacuum oven for 24 h at ambient temperature. This method was selected in-lieu of contact with an absorbent because the initiator was dissolved to some degree in the remaining water, so drying by absorption would have extracted out the K₂CO₃ solids. By instead evacuating the precipitate via vacuum oven, the solids were forced from the solution by oversaturation-induced precipitation, thereby yielding a higher retention of the initiator. The dried solids were then characterized by SEM as shown in FIG. 14. From FIG. 14A it was observed that the bulk material was primarily nonporous but contained localized areas of macroporosity, likely caused by drying under vacuum and or mechanical fibrulation of the PTFE phase during the surfactant destabilization. FIGS. 14B and 14C revealed that two types of K₂CO₃ immobilization behavior were present at the microscopic levels. The first such behavior—denoted as a catenated structure (FIG. 14B)—shows the interconnection of K₂CO₃ particulate precipitated around PTFE fibers to form long-strands of particles forming catenated a catenated structure. This behavior arose from catenation of the K₂CO₃; namely, rapidly precipitating the solids via vacuum forced a fraction thereof to interconnect within one another and form an intertwined particle matrix. The catenated structure partially encapsulated some length of the PTFE fibrils, leading to a linearized network of the base initiator alongside the PTFE strands. The second such behavior—defined as a conglomerated structure (FIG. 14C)—referred to individual K₂CO₃ particles being observed at fibril nodes, with nodes being defined as the localities where individual PTFE strands come together and splice into a web-like network. The behavior of these conglomerated structures differed from catenated structures, as the former generated macroscopic and linearized particle/PTFE strands whereas the latter yielded more randomized localities of particulate clusters with higher macroporosity. In the latter case, some portion of the K₂CO₃ particulate would have precipitated around the PTFE nodules, which was similar to the macroscopic embedment of multiple particles by the mechanism itself, but differed in the number and size of conglomerates. In either case, these materials are intended to be used in corrosive gas capture, specifically adsorption of SO₂, H₂S, NO₂, NO, SO₃, and NH₃ (for acidic initiators) in air purification applications. The materials can also be used for secondary growth of metal-organic frameworks (MOFs) by using an acidic ligand initiator—such as trimesic acid—followed by secondary coordination of the acid sites with a copper salt (Cu(NO₃)₂·2.5H₂O) to form Cu(BTC)₂. It is also intended to use these materials for the abatement of basic gases following a similar process but replacing the K₂CO₃ with a solid-state acid such as citric acid, terephthalic acid, trimesic acid, tartaric acid, maleic acid, benzoic acid, oxalic acid, or any combination thereof.

### Example 3

### Electrospinning a Composition That Includes Short-Strand PTFE Fibrils, Long-Strand PTFE Fibrils, and a Plurality of Active Particles

In this example, the particle/PTFE matrix is electrospun alongside a stabilizing agent—low strength gelatin or some other biopolymer—to form a plurality of fine nanofibers containing embedded and conglomerated particles. The biopolymer is then extracted at 200° C. for 3 h to generate a plurality of PTFE/particle nanofibers. The material ascribed here is prepared by first sonicating 15 g of PTFE-E with 5 g of PTFE-12 to generate a homogeneous emulsion of short- and long-PTFE fibers. 10 g of CARULITE and 15 g of DI are then added to the emulsion, followed by aeration of the solution to fully suspend the particles as described above. A solution of 3-10 g of gelatin in additional 20 g DI is then prepared by sonicating the gelatin for 15 minutes, allowing for full dissolution. The gelatin solution is then poured into the PTFE/CARULITE solution followed by vigorous agitation to aerate the slurry and homogenize the two components. The solution is then immediately transferred into the electrospinning apparatus to prevent gelling of the material. The fibers are then spun onto a nonporous substrate and allowed to dry for 24 h under vacuum. Thereafter, the gelatin is extracted by calcining in air at 200-230° C. to burn off the biopolymer. Alternative biopolymers—such as collagen or poly-lactic acid—as well as other synthetic polymers—such as polyurethane, poly(vinyl) alcohol, or nylon—may also act as the stabilizing agents for spinning the PTFE/particle mixture.

### Example 4

### Casting a Composition Into a Membrane

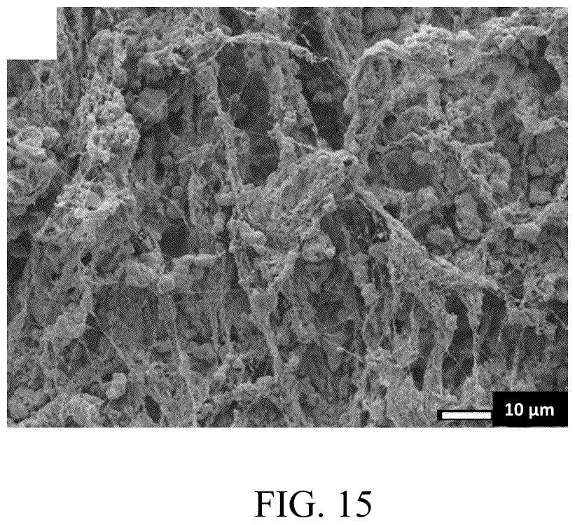

A composition was cast into a membrane as a proof-of-concept, with a slight change in the material recipe needed to generate the necessary rheology for casting. The aeration technique described previously was used to generate the membrane, but the of the slurry was 25 g PTFE-E, 5 g PTFE-12, 15 g CARULITE, and 20 g DI. The slurry was formed as before by aerating the PTFE-E/PTFE-12 mixture, however, DI was not added in the initial aeration step. Instead, the CARULITE was first suspended in the DI, followed by mixing the two solutions together via mechanical shaking. The final slurry was then poured into a cylindrical glass mold with particle size of 5 inches (1.27 cm) and height of 0.5 inches (1.27 cm). The membrane was then set overnight in a fume hood at ambient temperature, uncovered, to coagulate the suspension and begin drying. Finally, the membrane was contacted with an absorbent surface ten times, followed by final drying under vacuum at ambient temperature to extract the surfactant. Inspecting the membrane before and after drying revealed that small flecks of PTFE-12 were present in the surface, but these were considered to be artifacts of emulsifying the PTFE-E and PTFE-12 together at small-scale after prior emulsion of the former component. It is generally regarded that PTFE solids should all be emulsified at the same time to generate a homogeneous colloidal suspension, so this slight heterogeneity is not present when beginning the process with a homogenized surfactant/water/PTFE emulsion containing a plurality of PTFE resin with different sizes. It was also observed in FIG. 15 that both large- and small- PTFE fibrils were present, which was consistent with the other materials.

What is claimed is:

1. A composition comprising:
a matrix comprising:
a plurality of polytetrafluoroethylene (PTFE) fibrils comprising:
short-strand PTFE fibrils; and
long-strand PTFE fibrils; and
a plurality of active particles.

2. The composition of claim 1, wherein at least a portion of the plurality of active particles and at least a portion of the plurality of PTFE particles adopt a catenated structure, a conglomerated structure, or both, when the composition is in an unstretched state.

3. The composition of claim 1, wherein the plurality of active particles comprises a catalyst, an adsorbent, a growth seed, a metal-organic framework, an electroactive material, or any combination thereof; wherein the adsorbent is a physisorbent, a chemisorbent, or a physisorbent-chemisorbent hybrid.

4. The composition of claim 3, wherein the catalyst is capable of ozone destruction.

5. The composition of claim 4, wherein the catalyst comprises manganese oxide, copper oxide, cerium dioxide, reduced metals, or any combination thereof.

6. The composition of claim 3, wherein the adsorbent is capable of adsorbing a basic compound, an acidic compound, an organic compound, an inorganic compound, or any combination thereof.

7. The composition of claim 1, wherein the composition comprises 0.01 wt-% to 30 wt-% of the long-strand PTFE fibrils based on the total weight of the composition and calculated according to the Composition Analysis Test Method.

8. The composition of claim 1, wherein the composition comprises 50 wt-% to 95 wt-% active particles on the total weight of the composition and calculated according to the Composition Analysis Test Method.

9. A substrate comprising an external surface and the composition of claim 1 disposed on at least a portion of the external surface.

10. The substrate of claim 9, wherein the substrate is nonporous and wherein the substrate comprises a corrugated honeycomb; nonporous polyurethane; polyethylene honeycomb; silicon carbide honeycomb; cordierite honeycomb; or any combination thereof.

11. A method of making a composition, the composition comprising: a matrix, the matrix comprising:
a plurality of PTFE fibrils formed from PTFE resin;
and a plurality of active particles;
the method comprising:
aerating an emulsion to form an aerated emulsion, the emulsion and the aerated emulsion comprising:
the PTFE resin;
a dispersant; and
a surfactant;
adding a solid particulate composition to the aerated emulsion to form a matrix pre-mixture, the solid particulate composition comprising a solid particulate, the matrix pre-mixture comprising:
the PTFE resin;
the dispersant;
the solid particulate composition; and
the surfactant;
aerating the matrix pre-mixture to form an aerated matrix pre-mixture, the aerated matrix pre-mixture comprising:
the PTFE resin;
the solid particulate composition;
the dispersant;
and the surfactant;
mixing the aerated matrix pre-mixture to form a hydrated solid, the hydrated solid comprising:
the plurality of PTFE fibrils;
the plurality of active particles, the plurality of active particles comprising at least a portion of the solid particulate;
at least a portion of the dispersant; and
at least a portion of the surfactant; and
drying the hydrated solid to form the matrix.

12. The method of claim 11, wherein the plurality of PTFE fibrils comprises short-strand PTFE fibrils.

13. The method of claim 11, wherein the plurality of PTFE fibrils comprises long-strand PTFE fibrils and short-strand PTFE fibrils.

14. A method of disposing a composition on a substrate, the substrate comprising an external surface; the method comprising the method of claim 11, the method further comprising:
contacting at least a portion of the external surface of the substrate with the aerated matrix pre-mixture; and
mixing the aerated matrix pre-mixture while in contact with the at least a portion of the substrate such that at least a portion of the hydrated solid is formed on the external surface.

15. The method of claim 11, wherein the surfactant comprises a nonionic nonfluorinated surfactant.

16. A method of making a composition, the composition comprising: a matrix, the matrix comprising:
a plurality of PTFE fibrils formed from PTFE resin; and
a plurality of active particles;
the method comprising:
precipitating at least a portion of the particles of the PTFE resin from an (aerated) matrix pre-mixture through the addition of a solid particulate composition to the (aerated) matrix pre-mixture to form a hydrated solid; the solid particulate composition comprising a solid particulate; the (aerated) matrix pre-mixture comprising:
the PTFE resin;
a dispersant; and
a surfactant;
the hydrated solid comprising:
the plurality of active particles, the plurality of active particles comprising at least a portion of the solid particulate;
at least a portion of the dispersant; and
at least a portion of the surfactant; and
drying the hydrated solid to form the matrix.

17. The method of claim 16, wherein the plurality of PTFE fibrils comprises short-strand PTFE fibrils.

18. The method of claim 16, wherein the plurality of PTFE fibrils comprises long-strand PTFE fibrils and short-strand PTFE fibrils.

19. A method of disposing a composition on a substrate, the substrate comprising an external surface; the method comprising the method of claim 16, the method further comprising:
contacting at least a portion of the external surface of the substrate with the (aerated) matrix pre-mixture; and
precipitating at least a portion of the emulsified PFTE resin from an aerated matrix-pre mixture through the addition of a solid particulate composition to the (aerated) matrix pre-mixture to form at least a portion of a hydrated solid on the external surface.

20. The method of claim 16, wherein the surfactant comprises a nonionic nonfluorinated surfactant.
